(19) United States
(12) Patent Application Publication
(10) Pub. No.: US 2023/0093136 A1
(43) Pub. Date: Mar. 23, 2023

(54) SYSTEMS AND METHODS FOR GENERATING AUDIENCES VIA A SECURE AND PROPORTIONAL DATA EXCHANGE

(71) Applicant: SHOPIFY INC., Ottawa (CA)

(72) Inventors: Andrew Feng ZHUANG, Waterloo (CA); Kyle Bruce TATE, Ottawa (CA); Eugene CHAE, Chicago, IL (US); Thomas CLEBERG, Omaha, NE (US); Xinyi ZHAO, Etobicoke (CA)

(21) Appl. No.: 17/479,650

(22) Filed: Sep. 20, 2021

(51) Int. Cl. G06Q 30/02; G06F 21/62

(52) U.S. Cl. CPC G06Q 30/0253; G06Q 30/0246; G06Q 30/0254; G06Q 30/0201; G06F 21/6263

(57) ABSTRACT

Methods and systems of securely exchanging customer data are provided. The exchange may be done in privacy-preserving and/or privacy-protective fashion. Customer data from multiple merchants, including transaction data for a first product between a first customer and a first merchant, is maintained in a customer data pool by an e-commerce platform. When a second merchant associated with a second product requests new customer data, a product (i.e., the first product) relevant to the second product is identified. A collection of customers who indicated interest in the first product (including the first customer) are identified from the customer data pool, and a target audience is generated proportional to customer data exchanged by the second merchant with the customer data pool. Communications from the second merchant are then provided to the target audience without disclosing their customer data to the second merchant.

### FIELD

The present disclosure is related to secure data exchange on an e-commerce platform. In particular, the present disclosure relates to methods and systems for securely exchanging customer data in a privacy-respecting fashion for use in generating, based on product complementarity and the data exchange, audiences for advertising.

### BACKGROUND

With the rise of online retail channels, the desire for targeted advertising is increasing as merchants wish to seek new customers while minimizing the cost of “wasted” advertisements to people with a low likelihood of purchasing their product(s)/service(s) (for simplicity, the term “products” will be used to refer to both physical products and services).

However, there are concerns surrounding privacy and security with regards to this type of targeting, as targeted advertising generally requires the collection of personal data (which could include sensitive information), which may then be exchanged between merchants/advertisers, potentially without the customers' awareness or permission.

Permission may be sought from customers in order to collect and use their data for marketing purposes. However, even still, it may be difficult for merchants to identify which customers outside their usual customer base are more likely to purchase their product(s) and target them with the merchant's advertising. Indeed, in many cases traffic to online stores don't end up converting into a sale (for example, in some ecommerce platforms, only about 2.5% of traffic converts to a sale).

With customer data a merchant can collect themselves (such as their own sales data, associated customer information, and website activity), either the merchant may not want to share with their competitors, and/or the merchant may not be able to share the collected data due to privacy and security regulations. Even if customer data is shared between merchants, it may also be difficult for the recipient merchant to verify the fidelity of the customer data it receives and/or to assess the data's value.

### SUMMARY

While online traffic to a merchant's store that converts into a sale is the strongest indication of a customer's interest in the product, non-converting traffic information also signals timely customer intent because they inform a merchant when customers are in the market for a particular kind of product.

Therefore, a network of merchants and customers is needed to exchange customer data in a timely manner for merchants to reach customers just-in-time when they are making purchasing decisions. This data exchange may help merchants acquire new customers and improve their return on ad spend (ROAS). (ROAS is a metric that represents revenue generation relative to advertising expenditure.) However, it is desirable that this data exchange have certain properties as will now be discussed.

First, it is highly important that the data exchange be secure so that customers' privacy is not compromised.

Furthermore, it may, additionally, be desired that this data exchange be “fair”; that is to say, such that all of the merchants participating in an exchange benefit proportionally in terms of the value of the data they exchange via the exchange—i.e. such that the value of incoming customer data is proportional to the value of outgoing customer data.

Yet further, it is important that the exchange of customer data be performed in real-time (or near real-time) due to the fact that customer purchasing decisions can change rapidly.

Supporting real-time exchange of customer data in a secure way among multiple merchants while ensuring fairness (e.g., to avoid one merchant benefiting from the data exchanged by others without participating in the data exchange) is not trivial. The disclosed systems and methods provide the ability to monitor and adjust the exchanged customer data in real-time, based on monitored real-time customer activity (e.g., customer conversion rate), to ensure fairness among merchants. This time sensitivity means that implementation using manual means (e.g., a human monitoring conversion rates) is not practical or possible. Further, the disclosed systems and methods provide a secure way to exchange customer data among merchants, without unnecessary exposure of sensitive customer data. Such security relies on the use of a trusted electronic platform as an intermediary, and thus cannot be replicated using manual means.

By way of overview, according to the subject matter of the present application, merchants may participate in a data exchange pool to build audiences not only based on data about their own customers data but also customers of other merchants that agree to participate in a co-operative data exchange. The system, which may be part of or associated with an e-commerce platform already managing the customer data, may build audiences that can then be used for advertising. As discussed above, these audiences may be built in a fair way. Further, privacy may be protected such as by not exposing details of such audiences directly to the merchants, and instead, for example, only provide merchants with information about the audience (e.g., size) while only providing information about the members of the audiences to an advertising entity (e.g., Facebook) and potentially only to the extent required in order to advertise to that audience (e.g., data related to e-commerce transactions may not be provided). Notably, this means that, assuming merchants were already advertising to their own customers via such an advertising entity, then the risk of other parties (e.g., other merchants) gaining information, via the data exchange, about a customer that they would not have already known is avoided and/or minimized. For example, a merchant may already have information about its own customers and their transactions, an e-commerce platform may already have such information for its various merchants, and an advertising entity may already know details about persons to whom it may advertise.

Thus, in some examples, the present disclosure describes a computer-implemented method comprising: pooling customer data associated with a plurality of merchants in a customer data pool maintained by the e-commerce platform, the customer data including transaction data associated with transactions between the plurality of merchants and customers of those plurality of merchants, the transaction data including data for a transaction for a first product between a first customer of a first merchant of the plurality of merchants and the first merchant; using the customer data pool to generate a target audience for a second merchant of the plurality of merchants, the second merchant being associated with a second product, the generating including: identifying a related product relevant to the second product, the related product being the first product associated with the first merchant; identifying, from the customer data pool, a collection of customers who have indicated interest in the first product, the identified collection of customers including the first customer who is associated with the first product; and generating a target audience of target customers from the collection of customers, including the first customer, wherein the size of the target audience is proportional to customer data exchanged by the second merchant with the customer data pool; and providing communications from the second merchant to one or more of the target customers of the target audience without disclosing the customer data associated with the target audience to the second merchant.

In any of the above examples, the method may further comprise verifying the transaction for the first product between the first customer and the first merchant, and storing, by the e-commerce platform, the data for the transaction.

In any of the above examples, the pooling may comprise receiving, from the first merchant, an indication that customer data of the first merchant should be exchanged with the customer data pool.

In any of the above examples, the computer-implemented method may further comprise receiving, from the second merchant, the number of target customers of the target audience that the second merchant wishes to provide the communications to.

In any of the above examples, the computer-implemented method may further comprise monitoring an actual conversion rate of the one or more target customers for the second merchant in real time, the actual conversion rate being a number of purchases of the second product from the second merchant by the one or more target customers who received the communications; and responsive to determining that the actual conversion rate differs from an expected conversion rate, the expected conversion rate being an expected number of purchases of the second product from the second merchant by the one or more target customers who received the communications, adjusting the size of the target audience; wherein the monitoring and the adjusting are repeated in real-time to bring the actual conversion rate towards a predetermined amount of net benefit to the second merchant.

In any of the above examples, the computer-implemented method may also include conducting the transaction between the first customer and the first merchant.

In any of the above examples, the computer-implemented method may further include identifying, from the customer data pool, another collection of customers who have indicated interest in the second product, the identified other collection of customers including a second customer who is associated with the second product; generating another target audience of other target customers from the other collection of customers, wherein the size of other target audience is proportional to customer data exchanged by the first merchant with the customer data pool; and providing communications from the first merchant to one or more of the other target customers of the other target audience without disclosing the customer data associated with the other target audience to the first merchant.

In any of the above examples, the customer data exchanged by the first merchant may include customer data associated with the first customer, the first customer being associated with the verified transaction with the first merchant, and customer data associated with a third customer, the third customer not being associated with any verified transaction with the first merchant; wherein a generated number of other target customers that is proportional to the customer data associated with the first customer is larger than a generated number of other target customers that is proportional to the customer data associated with the third customer.

In any of the above examples, the target customers of the target audience may be generated further based on one or more proportionality parameters, including at least one of: predicted conversion rates; target customer interest scores; product complementarity scores; multiple merchants previously targeting the target customer; predicted profit for the second merchant; recency of customer data exchanged with the pool by the second merchant; or configuration data associated with the second merchant.

In any of the above examples, the computer-implemented method may further include ranking the target customers according to the one or more proportionality parameters.

In any of the above examples, the collection of customers from the customer data pool may be identified by indicated interest in the first product, wherein indicated interest may be determined by tracking at least one of a purchase of the first product; entry of the first product into a virtual cart; viewing a product page containing the first product; search for the first product; or viewing a review of the first product

In any of the above examples, identifying the second product that is relevant to the first product may be based on a complementarity or similarity matrix.

In some example aspects, the present disclosure describes a computer system of providing secure exchange of customer data, the computer system comprising: at least one processor and at least one memory, the at least one memory storing a customer data pool comprising customer data associated with a plurality of merchants maintained by the e-commerce platform, the customer data including transaction data associated with transactions between a plurality of merchants and customers of the plurality of merchants, the transaction data including data for a transaction for a first product between a first customer of a first merchant of the plurality of merchants and the first merchant; the at least one memory further storing instructions executable by the at least one processor to cause the computer system to: generate a target audience using the customer data pool for a second merchant of the plurality of merchants, the second merchant being associated with a second product, by: identifying a related product relevant to the second product, the related product being the first product associated with the first merchant; identifying, from the customer data pool, a collection of customers who have indicated interest in the first product, the identified collection of customers including the first customer who is associated with the first product; and generating a target audience of target customers from the collection of customers, including the first customer, wherein the size of the target audience is proportional to customer data exchanged by the second merchant with the customer data pool; and provide communications from the second merchant to one or more of the target customers of the target audience without disclosing the customer data associated with the target audience to the second merchant.

In some examples, the processor may be configured to execute instructions to cause the computer system to perform any of the methods described herein.

In some example aspects, the present disclosure describes a non-transitory computer-readable medium storing instructions that, when executed by a processor of a system, cause the system to: pool customer data associated with a plurality of merchants in a customer data pool maintained by the e-commerce platform, the customer data including transaction data associated with transactions between the plurality of merchants and customers of those plurality of merchants, the transaction data including data for a transaction for a first product between a first customer of a first merchant of the plurality of merchants and the first merchant; generate a target audience for a second merchant of the plurality of merchants using the customer data pool, the second merchant being associated with a second product, the generation including: identifying a related product relevant to the second product, the related product being the first product associated with the first merchant; identifying, from the customer data pool, a collection of customers who have indicated interest in the first product, the identified collection of customers including the first customer who is associated with the first product; and generating a target audience of target customers from the collection of customers, including the first customer, wherein the size of the target audience is proportional to customer data exchanged by the second merchant with the customer data pool; and provide communications from the second merchant to one or more of the target customers of the target audience without disclosing the customer data associated with the target audience to the second merchant.

In some examples, the non-transitory computer-readable medium, when executed by the processor, may cause the advertising platform to perform any of the methods described herein.

### BRIEF DESCRIPTION OF THE DRAWINGS

Reference will now be made, by way of example, to the accompanying drawings which show example embodiments of the present application, and in which:

FIG. 1 is a block diagram of an example e-commerce platform, in which examples described herein may be implemented;

FIG. 2 is an example homepage of an administrator, which may be accessed via the e-commerce platform of FIG. 1;

FIG. 3 is another block diagram of the e-commerce platform of FIG. 1, showing some details related to application development;

FIG. 4 is a block diagram illustrating an example implementation of the e-commerce platform of FIG. 1;

FIG. 5 is another block diagram of the e-commerce platform of FIG. 1, showing details related to providing secure exchange of customer data;

FIGS. 6A-6D are a schematics illustrating sequential stages in an example use of the e-commerce platform of FIG. 5; and

FIG. 7 is a flowchart illustrating an example method for providing secure exchange of customer data, which may be implemented using the data exchange manager, in accordance with examples of the present disclosure;

Similar reference numerals may have been used in different figures to denote similar components.

### DESCRIPTION OF EXAMPLE EMBODIMENTS

The present disclosure describes a method and system for an e-commerce platform to aggregate its own direct transaction data and indirect customer data from participating merchants in a pool, identify relevant customers for a merchant's given product from the pool based on a product complementarity/similarity matrix, and generate a target audience from those relevant customers for targeted advertising by the merchant in a manner intended to promote fairness in the exchange, as well as privacy and security of the exchanged data. More particularly, regarding fairness, the exchange of customer data is such that a merchant is incentivized to exchange their customer data, as the number of relevant customers included in the target audience provided to the merchant will be generally proportional to the amount/value of customer data the merchant contributes to the pool. Further, examples of the present disclosure may enable customer activity (e.g., customer conversion rate) to be monitored in real-time, such that fairness among merchants may be maintained in real-time (e.g., to avoid any one merchant unfairly benefiting from the pool, even for a short time such as one day). Privacy and security of customer data may be ensured by providing merchants (and third-party channels used for targeted advertising) with only the minimum amount of information about the generated target audience (e.g., size of the audience) without any information that would explicitly or implicitly identify the customers belonging to the target audience.

It should be understood that, in the present disclosure, the exchange of data does not necessarily refer to an actual change in ownership of data or a change in where data is being stored. In the present disclosure, data may be exchanged in the sense of a notional exchange, where the original owner of the data does not necessarily lose ownership of the data but offers the data to be made useable by others, in exchange for some benefit (such ability to make use of others' data). In the present disclosure, references to a merchant exchanging data with the pool may be understood to mean the merchant making the data available to be used by the pool, in exchange for the ability to make use of a proportionate amount of data from other merchants. It should be understood that, in some examples, exchanging data may involve some sharing of data. For example, in at least some implementations, a given merchant exchanging data with the pool may involve sharing data with the pool, however that shared data is not further shared between the pool and a different merchant. That is, in cases where exchanging data involves any sharing of data (it bears repeating that exchanging data does not necessarily involve actual sharing of data, but may rather be a notional exchange), customer privacy and security can be protected because merchants may not gain data from the pool that they would not otherwise have access to.

An e-commerce platform is uniquely situated to help implement the present methods and systems for data exchange and targeting advertising because it already has direct access to customer and transaction data of its online merchants. Notably, as further described below, this means that the subject matter of the present application may be implemented without unnecessary disclosure of customer information to third parties, particularly third-party merchants. The customer information will, in most cases, already be known to the e-commerce platform through the ordinary use and operation thereof. It can determine whether a certain transaction or sale with a particular merchant has actually taken place, thereby confirming its relevance. Combining this additional layer of information with data as may be provided by the merchants, allows for a better assessment of the value of the merchant's incoming customer data, prevents fraudulent customer information being submitted (e.g., by bad actors wishing to take advantage of the exchange of information), protects against customer's loss of privacy, and helps to ensure more fair and proportional outgoing customer data. In particular, the e-commerce platform is able to provide this security and privacy without introducing time delays (which would be necessary if attempted using manual means), thus ensuring that fairness can be maintained on a real-time basis.

As such, the present disclosure will be described in the context of an e-commerce platform, discussed below. However, it should be understood that this discussion is only for the purpose of illustration of an example e-commerce platform and is not intended to be limiting as to the nature of an e-commerce system with which the subject matter of the present application may be implemented. Further, it should be understood that the present disclosure may be implemented in other contexts, and is not necessarily limited to implementation in an e-commerce platform though, as discussed elsewhere in the present application, there may be particular advantages to implementation in the context of an e-commerce platform. For example, the customer data exchange and targeted advertisements may be performed by or on another trusted third-party platform. Other such possibilities are contemplated within the scope of the present disclosure.

An Example e-Commerce Platform

Although integration with a commerce platform is not required, in some embodiments, the methods disclosed herein may be performed on or in association with a commerce platform such as an e-commerce platform. Therefore, an example of a commerce platform will be described.

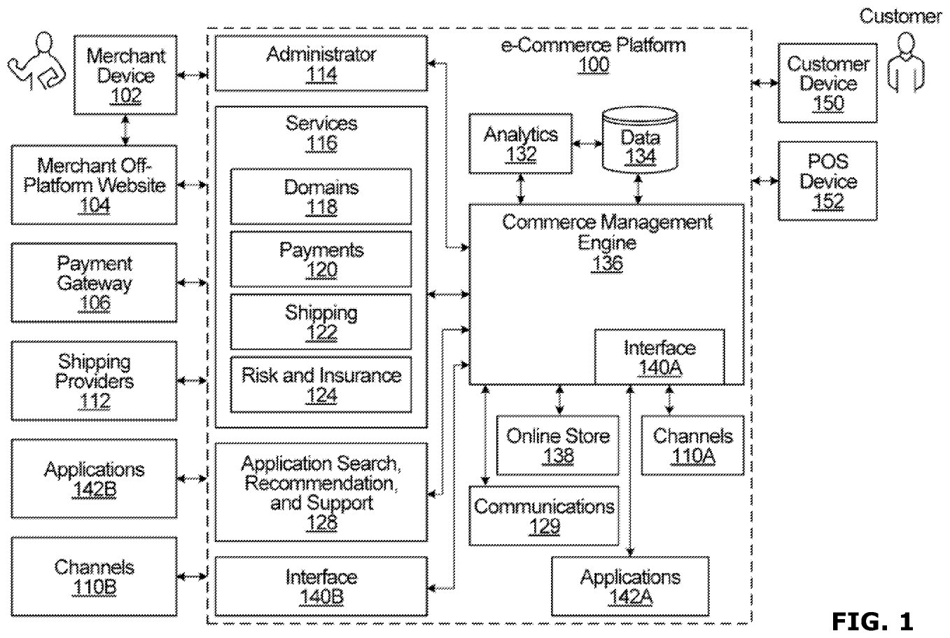

FIG. 1 illustrates an example e-commerce platform 100, according to one embodiment. The e-commerce platform 100 may be used to provide merchant products and services to customers. While the disclosure contemplates using the apparatus, system, and process to purchase products and services, for simplicity the description herein will refer to products. All references to products throughout this disclosure should also be understood to be references to products and/or services, including, for example, physical products, digital content (e.g., music, videos, games), software, tickets, subscriptions, services to be provided, and the like.

While the disclosure throughout contemplates that a ‘merchant’ and a ‘customer’ may be more than individuals, for simplicity the description herein may generally refer to merchants and customers as such. All references to merchants and customers throughout this disclosure should also be understood to be references to groups of individuals, companies, corporations, computing entities, and the like, and may represent for-profit or not-for-profit exchange of products. Further, while the disclosure throughout refers to ‘merchants’ and ‘customers’, and describes their roles as such, the e-commerce platform 100 should be understood to more generally support users in an e-commerce environment, and all references to merchants and customers throughout this disclosure should also be understood to be references to users, such as where a user is a merchant-user (e.g., a seller, retailer, wholesaler, or provider of products), a customer-user (e.g., a buyer, purchase agent, consumer, or user of products), a prospective user (e.g., a user browsing and not yet committed to a purchase, a user evaluating the e-commerce platform 100 for potential use in marketing and selling products, and the like), a service provider user (e.g., a shipping provider 112, a financial provider, and the like), a company or corporate user (e.g., a company representative for purchase, sales, or use of products; an enterprise user; a customer relations or customer management agent, and the like), an information technology user, a computing entity user (e.g., a computing bot for purchase, sales, or use of products), and the like. Furthermore, it may be recognized that while a given user may act in a given role (e.g., as a merchant) and their associated device may be referred to accordingly (e.g., as a merchant device) in one context, that same individual may act in a different role in another context (e.g., as a customer) and that same or another associated device may be referred to accordingly (e.g., as a customer device). For example, an individual may be a merchant for one type of product (e.g., shoes), and a customer/consumer of other types of products (e.g., groceries). In another example, an individual may be both a consumer and a merchant of the same type of product. In a particular example, a merchant that trades in a particular category of goods may act as a customer for that same category of goods when they order from a wholesaler (the wholesaler acting as merchant).

The e-commerce platform 100 provides merchants with online services/facilities to manage their business. The facilities described herein are shown implemented as part of the platform 100 but could also be configured separately from the platform 100, in whole or in part, as stand-alone services. Furthermore, such facilities may, in some embodiments, may, additionally or alternatively, be provided by one or more providers/entities.

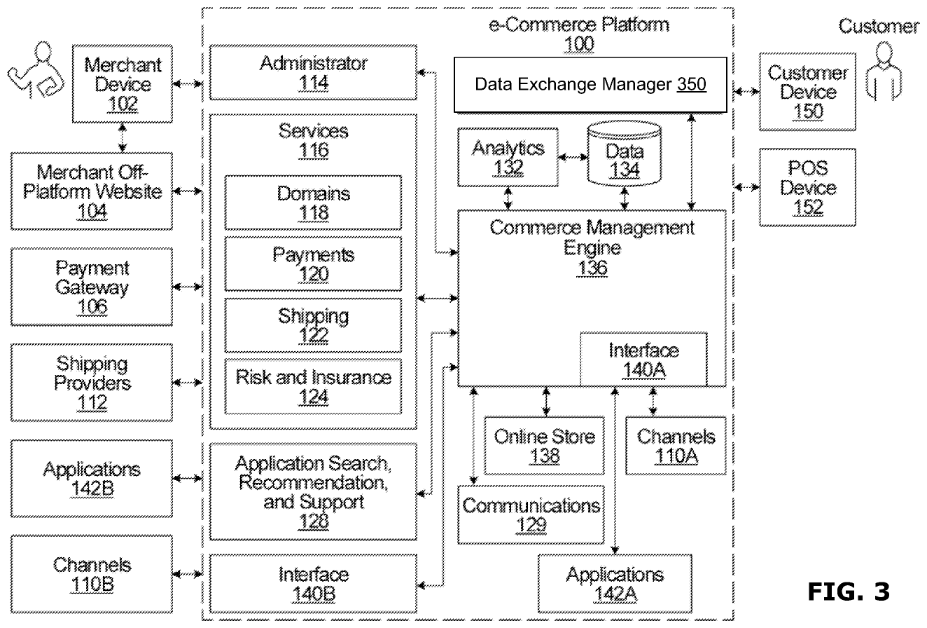

In the examples of FIGS. 1 and 3, the facilities are deployed through a machine, service or engine that executes computer software, modules, program codes, and/or instructions on one or more processors which, as noted above, may be part of or external to the platform 100. Merchants may utilize the e-commerce platform 100 for enabling or managing commerce with customers, such as by implementing an e-commerce experience with customers through an online store 138, applications 142A-B, channels 110A-B, and/or through point of sale (POS) devices 152 in physical locations (e.g., a physical storefront or other location such as through a kiosk, terminal, reader, printer, 3D printer, and the like). A merchant may utilize the e-commerce platform 100 as a sole commerce presence with customers, or in conjunction with other merchant commerce facilities, such as through a physical store (e.g., ‘brick-and-mortar’ retail stores), a merchant off-platform website 104 (e.g., a commerce Internet website or other internet or web property or asset supported by or on behalf of the merchant separately from the e-commerce platform 100), an application 142B, and the like. However, even these ‘other’ merchant commerce facilities may be incorporated into or communicate with the e-commerce platform 100, such as where POS devices 152 in a physical store of a merchant are linked into the e-commerce platform 100, where a merchant off-platform website 104 is tied into the e-commerce platform 100, such as, for example, through ‘buy buttons’ that link content from the merchant off platform website 104 to the online store 138, or the like.

The online store 138 may represent a multi-tenant facility comprising a plurality of virtual storefronts. In embodiments, merchants may configure and/or manage one or more storefronts in the online store 138, such as, for example, through a merchant device 102 (e.g., computer, laptop computer, mobile computing device, and the like), and offer products to customers through a number of different channels 110A-B (e.g., an online store 138; an application 142A-B; a physical storefront through a POS device 152; an electronic marketplace, such, for example, through an electronic buy button integrated into a website or social media channel such as on a social network, social media page, social media messaging system; and/or the like). A merchant may sell across channels 110A-B and then manage their sales through the e-commerce platform 100, where channels 110A may be provided as a facility or service internal or external to the e-commerce platform 100. A merchant may, additionally or alternatively, sell in their physical retail store, at pop ups, through wholesale, over the phone, and the like, and then manage their sales through the e-commerce platform 100. A merchant may employ all or any combination of these operational modalities. Notably, it may be that by employing a variety of and/or a particular combination of modalities, a merchant may improve the probability and/or volume of sales. Throughout this disclosure the terms online store 138 and storefront may be used synonymously to refer to a merchant's online e-commerce service offering through the e-commerce platform 100, where an online store 138 may refer either to a collection of storefronts supported by the e-commerce platform 100 (e.g., for one or a plurality of merchants) or to an individual merchant's storefront (e.g., a merchant's online store).

In some embodiments, a customer may interact with the platform 100 through a customer device 150 (e.g., computer, laptop computer, mobile computing device, or the like), a POS device 152 (e.g., retail device, kiosk, automated (self-service) checkout system, or the like), and/or any other commerce interface device known in the art. The e-commerce platform 100 may enable merchants to reach customers through the online store 138, through applications 142A-B, through POS devices 152 in physical locations (e.g., a merchant's storefront or elsewhere), to communicate with customers via electronic communication facility 129, and/or the like so as to provide a system for reaching customers and facilitating merchant services for the real or virtual pathways available for reaching and interacting with customers.

In some embodiments, and as described further herein, the e-commerce platform 100 may be implemented through a processing facility. Such a processing facility may include a processor and a memory. The processor may be a hardware processor. The memory may be and/or may include a non-transitory computer-readable medium. The memory may be and/or may include random access memory (RAM) and/or persisted storage (e.g., magnetic storage). The processing facility may store a set of instructions (e.g., in the non-transitory memory) that, when executed, cause the e-commerce platform 100 to perform the e-commerce and support functions as described herein. The processing facility may be or may be a part of one or more of a server, client, network infrastructure, mobile computing platform, cloud computing platform, stationary computing platform, and/or some other computing platform, and may provide electronic connectivity and communications between and amongst the components of the e-commerce platform 100, merchant devices 102, payment gateways 106, applications 142A-B, channels 110A-B, shipping providers 112, customer devices 150, point of sale devices 152, etc. In some implementations, the processing facility may be or may include one or more such computing devices acting in concert. For example, it may be that a plurality of co-operating computing devices serves as/to provide the processing facility. The e-commerce platform 100 may be implemented as or using one or more of a cloud computing service, software as a service (SaaS), infrastructure as a service (IaaS), platform as a service (PaaS), desktop as a service (DaaS), managed software as a service (MSaaS), mobile backend as a service (MBaaS), information technology management as a service (ITMaaS), and/or the like. For example, it may be that the underlying software implementing the facilities described herein (e.g., the online store 138) is provided as a service, and is centrally hosted (e.g., and then accessed by users via a web browser or other application, and/or through customer devices 150, POS devices 152, and/or the like). In some embodiments, elements of the e-commerce platform 100 may be implemented to operate and/or integrate with various other platforms and operating systems.

In some embodiments, the facilities of the e-commerce platform 100 (e.g., the online store 138) may serve content to a customer device 150 (using data 134) such as, for example, through a network connected to the e-commerce platform 100. For example, the online store 138 may serve or send content in response to requests for data 134 from the customer device 150, where a browser (or other application) connects to the online store 138 through a network using a network communication protocol (e.g., an internet protocol). The content may be written in machine readable language and may include Hypertext Markup Language (HTML), template language, JavaScript, and the like, and/or any combination thereof.

In some embodiments, online store 138 may be or may include service instances that serve content to customer devices and allow customers to browse and purchase the various products available (e.g., add them to a cart, purchase through a buy-button, and the like). Merchants may also customize the look and feel of their website through a theme system, such as, for example, a theme system where merchants can select and change the look and feel of their online store 138 by changing their theme while having the same underlying product and business data shown within the online store's product information. It may be that themes can be further customized through a theme editor, a design interface that enables users to customize their website's design with flexibility. Additionally or alternatively, it may be that themes can, additionally or alternatively, be customized using theme-specific settings such as, for example, settings as may change aspects of a given theme, such as, for example, specific colors, fonts, and pre-built layout schemes. In some implementations, the online store may implement a content management system for website content. Merchants may employ such a content management system in authoring blog posts or static pages and publish them to their online store 138, such as through blogs, articles, landing pages, and the like, as well as configure navigation menus. Merchants may upload images (e.g., for products), video, content, data, and the like to the e-commerce platform 100, such as for storage by the system (e.g., as data 134). In some embodiments, the e-commerce platform 100 may provide functions for manipulating such images and content such as, for example, functions for resizing images, associating an image with a product, adding and associating text with an image, adding an image for a new product variant, protecting images, and the like.

As described herein, the e-commerce platform 100 may provide merchants with sales and marketing services for products through a number of different channels 110A-B, including, for example, the online store 138, applications 142A-B, as well as through physical POS devices 152 as described herein. The e-commerce platform 100 may, additionally or alternatively, include business support services 116, an administrator 114, a warehouse management system, and the like associated with running an on-line business, such as, for example, one or more of providing a domain registration service 118 associated with their online store, payment facility 120 for facilitating transactions with a customer, shipping services 122 for providing customer shipping options for purchased products, fulfillment services for managing inventory, risk and insurance services 124 associated with product protection and liability, merchant billing, and the like. Services 116 may be provided via the e-commerce platform 100 or in association with external facilities, such as through a payment gateway 106 for payment processing, shipping providers 112 for expediting the shipment of products, and the like.

In some embodiments, the e-commerce platform 100 may be configured with shipping services 122 (e.g., through an e-commerce platform shipping facility or through a third-party shipping carrier), to provide various shipping-related information to merchants and/or their customers such as, for example, shipping label or rate information, real-time delivery updates, tracking, and/or the like.

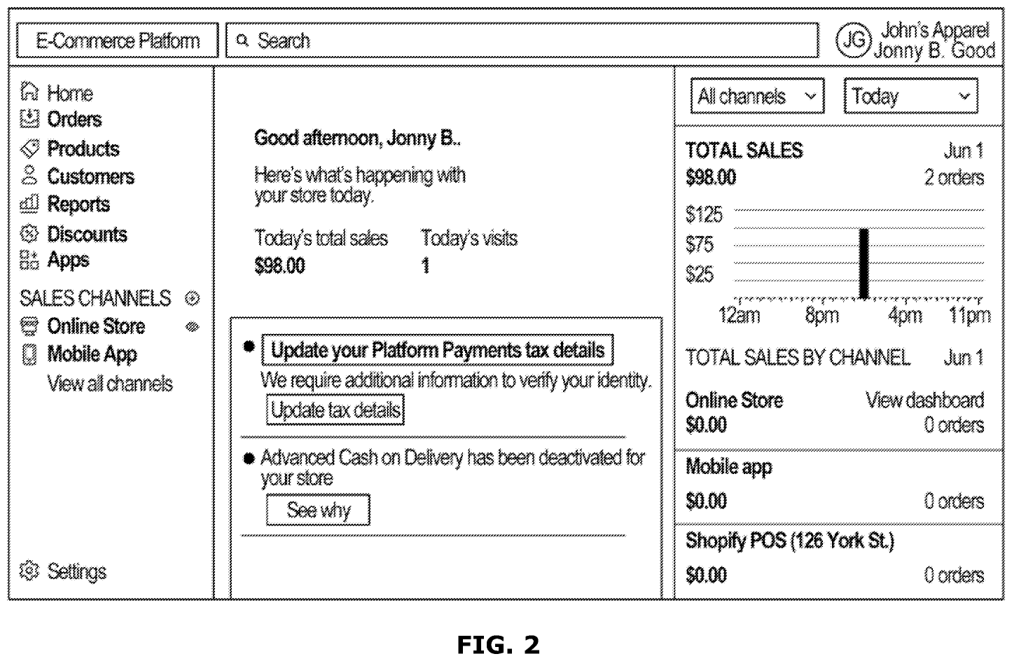

FIG. 2 depicts a non-limiting embodiment for a home page of an administrator 114. The administrator 114 may be referred to as an administrative console and/or an administrator console. The administrator 114 may show information about daily tasks, a store's recent activity, and the next steps a merchant can take to build their business. In some embodiments, a merchant may log in to the administrator 114 via a merchant device 102 (e.g., a desktop computer or mobile device), and manage aspects of their online store 138, such as, for example, viewing the online store's 138 recent visit or order activity, updating the online store's 138 catalog, managing orders, and/or the like. In some embodiments, the merchant may be able to access the different sections of the administrator 114 by using a sidebar, such as the one shown on FIG. 2. Sections of the administrator 114 may include various interfaces for accessing and managing core aspects of a merchant's business, including orders, products, customers, available reports and discounts. The administrator 114 may, additionally or alternatively, include interfaces for managing sales channels for a store including the online store 138, mobile application(s) made available to customers for accessing the store (Mobile App), POS devices, and/or a buy button. The administrator 114 may, additionally or alternatively, include interfaces for managing applications (apps) installed on the merchant's account; and settings applied to a merchant's online store 138 and account. A merchant may use a search bar to find products, pages, or other information in their store.

More detailed information about commerce and visitors to a merchant's online store 138 may be viewed through reports or metrics. Reports may include, for example, acquisition reports, behavior reports, customer reports, finance reports, marketing reports, sales reports, product reports, and custom reports. The merchant may be able to view sales data for different channels 110A-B from different periods of time (e.g., days, weeks, months, and the like), such as by using drop-down menus. An overview dashboard may also be provided for a merchant who wants a more detailed view of the store's sales and engagement data. An activity feed in the home metrics section may be provided to illustrate an overview of the activity on the merchant's account. For example, by clicking on a ‘view all recent activity’ dashboard button, the merchant may be able to see a longer feed of recent activity on their account. A home page may show notifications about the merchant's online store 138, such as based on account status, growth, recent customer activity, order updates, and the like. Notifications may be provided to assist a merchant with navigating through workflows configured for the online store 138, such as, for example, a payment workflow, an order fulfillment workflow, an order archiving workflow, a return workflow, and the like.

The e-commerce platform 100 may provide for a communications facility 129 and associated merchant interface for providing electronic communications and marketing, such as utilizing an electronic messaging facility for collecting and analyzing communication interactions between merchants, customers, merchant devices 102, customer devices 150, POS devices 152, and the like, to aggregate and analyze the communications, such as for increasing sale conversions, and the like. For instance, a customer may have a question related to a product, which may produce a dialog between the customer and the merchant (or an automated processor-based agent/chatbot representing the merchant), where the communications facility 129 is configured to provide automated responses to customer requests and/or provide recommendations to the merchant on how to respond such as, for example, to improve the probability of a sale.

The e-commerce platform 100 may provide a payment facility 120 for secure financial transactions with customers, such as through a secure card server environment. The e-commerce platform 100 may store credit card information, such as in payment card industry data (PCI) environments (e.g., a card server), to reconcile financials, bill merchants, perform automated clearing house (ACH) transfers between the e-commerce platform 100 and a merchant's bank account, and the like. The payment facility 120 may also provide merchants and buyers with financial support, such as through the lending of capital (e.g., lending funds, cash advances, and the like) and provision of insurance. In some embodiments, online store 138 may support a number of independently administered storefronts and process a large volume of customer data on a daily basis for a variety of products and services. The customer data may include any customer information indicative of a customer, a customer account or transactions carried out by a customer such as, for example, contact information, billing information, shipping information, returns/refund information, discount/offer information, payment information, or online store events or information such as page views, product search information (search keywords, click-through events), product reviews, abandoned carts, and/or other transactional information associated with business through the e-commerce platform 100. In some embodiments, the e-commerce platform 100 may store this data in a data facility 134. Referring again to FIG. 1, in some embodiments the e-commerce platform 100 may include a commerce management engine 136 such as may be configured to perform various workflows for task automation or content management related to products, inventory, customers, orders, suppliers, reports, financials, risk and fraud, and the like. In some embodiments, additional functionality may, additionally or alternatively, be provided through applications 142A-B to enable greater flexibility and customization required for accommodating an ever-growing variety of online stores, POS devices, products, and/or services. Applications 142A may be components of the e-commerce platform 100 whereas applications 142B may be provided or hosted as a third-party service external to e-commerce platform 100. The commerce management engine 136 may accommodate store-specific workflows and in some embodiments, may incorporate the administrator 114 and/or the online store 138.

Implementing functions as applications 142A-B may enable the commerce management engine 136 to remain responsive and reduce or avoid service degradation or more serious infrastructure failures, and the like.

Although isolating online store data can be important to maintaining data privacy between online stores 138 and merchants, there may be reasons for collecting and using cross-store data, such as, for example, with an order risk assessment system or a platform payment facility, both of which require information from multiple online stores 138 to perform well. In some embodiments, it may be preferable to move these components out of the commerce management engine 136 and into their own infrastructure within the e-commerce platform 100.

Platform payment facility 120 is an example of a component that utilizes data from the commerce management engine 136 but is implemented as a separate component or service. The platform payment facility 120 may allow customers interacting with online stores 138 to have their payment information stored safely by the commerce management engine 136 such that they only have to enter it once. When a customer visits a different online store 138, even if they have never been there before, the platform payment facility 120 may recall their information to enable a more rapid and/or potentially less-error prone (e.g., through avoidance of possible mis-keying of their information if they needed to instead re-enter it) checkout. This may provide a cross-platform network effect, where the e-commerce platform 100 becomes more useful to its merchants and customers as more merchants and customers join, such as because there are more customers who checkout more often because of the ease of use with respect to customer purchases. To maximize the effect of this network, payment information for a given customer may be retrievable and made available globally across multiple online stores 138.

For functions that are not included within the commerce management engine 136, applications 142A-B provide a way to add features to the e-commerce platform 100 or individual online stores 138. For example, applications 142A-B may be able to access and modify data on a merchant's online store 138, perform tasks through the administrator 114, implement new flows for a merchant through a user interface (e.g., that is surfaced through extensions/API), and the like. Merchants may be enabled to discover and install applications 142A-B through application search, recommendations, and support 128. In some embodiments, the commerce management engine 136, applications 142A-B, and the administrator 114 may be developed to work together. For instance, application extension points may be built inside the commerce management engine 136, accessed by applications 142A and 142B through the interfaces 140B and 140A to deliver additional functionality, and surfaced to the merchant in the user interface of the administrator 114.

In some embodiments, applications 142A-B may deliver functionality to a merchant through the interface 140A-B, such as where an application 142A-B is able to surface transaction data to a merchant (e.g., App: “Engine, surface my app data in the Mobile App or administrator 114”), and/or where the commerce management engine 136 is able to ask the application to perform work on demand (Engine: “App, give me a local tax calculation for this checkout”).

Applications 142A-B may be connected to the commerce management engine 136 through an interface 140A-B (e.g., through REST (REpresentational State Transfer) and/or GraphQL APIs) to expose the functionality and/or data available through and within the commerce management engine 136 to the functionality of applications. For instance, the e-commerce platform 100 may provide API interfaces 140A-B to applications 142A-B which may connect to products and services external to the platform 100. The flexibility offered through use of applications and APIs (e.g., as offered for application development) enable the e-commerce platform 100 to better accommodate new and unique needs of merchants or to address specific use cases without requiring constant change to the commerce management engine 136. For instance, shipping services 122 may be integrated with the commerce management engine 136 through a shipping or carrier service API, thus enabling the e-commerce platform 100 to provide shipping service functionality without directly impacting code running in the commerce management engine 136.

Depending on the implementation, applications 142A-B may utilize APIs to pull data on demand (e.g., customer creation events, product change events, or order cancelation events, etc.) or have the data pushed when updates occur. A subscription model may be used to provide applications 142A-B with events as they occur or to provide updates with respect to a changed state of the commerce management engine 136. In some embodiments, when a change related to an update event subscription occurs, the commerce management engine 136 may post a request, such as to a predefined callback URL. The body of this request may contain a new state of the object and a description of the action or event. Update event subscriptions may be created manually, in the administrator facility 114, or automatically (e.g., via the API 140A-B). In some embodiments, update events may be queued and processed asynchronously from a state change that triggered them, which may produce an update event notification that is not distributed in real-time or near-real time.

In some embodiments, the e-commerce platform 100 may provide one or more of application search, recommendation and support 128. Application search, recommendation and support 128 may include developer products and tools to aid in the development of applications, an application dashboard (e.g., to provide developers with a development interface, to administrators for management of applications, to merchants for customization of applications, and the like), facilities for installing and providing permissions with respect to providing access to an application 142A-B (e.g., for public access, such as where criteria must be met before being installed, or for private use by a merchant), application searching to make it easy for a merchant to search for applications 142A-B that satisfy a need for their online store 138, application recommendations to provide merchants with suggestions on how they can improve the user experience through their online store 138, and the like. In some embodiments, applications 142A-B may be assigned an application identifier (ID), such as for linking to an application (e.g., through an API), searching for an application, making application recommendations, and the like.

Applications 142A-B may be grouped roughly into three categories: customer-facing applications, merchant-facing applications, integration applications, and the like. Customer-facing applications 142A-B may include an online store 138 or channels 110A-B that are places where merchants can list products and have them purchased (e.g., the online store, applications for flash sales (e.g., merchant products or from opportunistic sales opportunities from third-party sources), a mobile store application, a social media channel, an application for providing wholesale purchasing, and the like). Merchant-facing applications 142A-B may include applications that allow the merchant to administer their online store 138 (e.g., through applications related to the web or website or to mobile devices), run their business (e.g., through applications related to POS devices), to grow their business (e.g., through applications related to shipping (e.g., drop shipping), use of automated agents, use of process flow development and improvements), and the like. Integration applications may include applications that provide useful integrations that participate in the running of a business, such as shipping providers 112 and payment gateways 106.

As such, the e-commerce platform 100 can be configured to provide an online shopping experience through a flexible system architecture that enables merchants to connect with customers in a flexible and transparent manner. A typical customer experience may be better understood through an embodiment example purchase workflow, where the customer browses the merchant's products on a channel 110A-B, adds what they intend to buy to their cart, proceeds to checkout, and pays for the content of their cart resulting in the creation of an order for the merchant. The merchant may then review and fulfill (or cancel) the order. The product is then delivered to the customer. If the customer is not satisfied, they might return the products to the merchant.

In an example embodiment, a customer may browse a merchant's products through a number of different channels 110A-B such as, for example, the merchant's online store 138, a physical storefront through a POS device 152; an electronic marketplace, through an electronic buy button integrated into a website or a social media channel). In some cases, channels 110A-B may be modeled as applications 142A-B. A merchandising component in the commerce management engine 136 may be configured for creating, and managing product listings (using product data objects or models for example) to allow merchants to describe what they want to sell and where they sell it. The association between a product listing and a channel may be modeled as a product publication and accessed by channel applications, such as via a product listing API. A product may have many attributes and/or characteristics, like size and color, and many variants that expand the available options into specific combinations of all the attributes, like a variant that is size extra-small and green, or a variant that is size large and blue. Products may have at least one variant (e.g., a “default variant”) created for a product without any options. To facilitate browsing and management, products may be grouped into collections, provided product identifiers (e.g., stock keeping unit (SKU)) and the like. Collections of products may be built by either manually categorizing products into one (e.g., a custom collection), by building rulesets for automatic classification (e.g., a smart collection), and the like. Product listings may include 2D images, 3D images or models, which may be viewed through a virtual or augmented reality interface, and the like.

In some embodiments, a shopping cart object is used to store or keep track of the products that the customer intends to buy. The shopping cart object may be channel specific and can be composed of multiple cart line items, where each cart line item tracks the quantity for a particular product variant. Since adding a product to a cart does not imply any commitment from the customer or the merchant, and the expected lifespan of a cart may be in the order of minutes (not days), cart objects/data representing a cart may be persisted to an ephemeral data store.

The customer then proceeds to checkout. A checkout object or page generated by the commerce management engine 136 may be configured to receive customer information to complete the order such as the customer's contact information, billing information and/or shipping details. If the customer inputs their contact information but does not proceed to payment, the e-commerce platform 100 may (e.g., via an abandoned checkout component) transmit a message to the customer device 150 to encourage the customer to complete the checkout. For those reasons, checkout objects can have much longer lifespans than cart objects (hours or even days) and may therefore be persisted. Customers then pay for the content of their cart resulting in the creation of an order for the merchant. In some embodiments, the commerce management engine 136 may be configured to communicate with various payment gateways and services 106 (e.g., online payment systems, mobile payment systems, digital wallets, credit card gateways) via a payment processing component. The actual interactions with the payment gateways 106 may be provided through a card server environment. At the end of the checkout process, an order is created. An order is a contract of sale between the merchant and the customer where the merchant agrees to provide the goods and services listed on the order (e.g., order line items, shipping line items, and the like) and the customer agrees to provide payment (including taxes). Once an order is created, an order confirmation notification may be sent to the customer and an order placed notification sent to the merchant via a notification component. Inventory may be reserved when a payment processing job starts to avoid over-selling (e.g., merchants may control this behavior using an inventory policy or configuration for each variant). Inventory reservation may have a short time span (minutes) and may need to be fast and scalable to support flash sales or “drops”, which are events during which a discount, promotion or limited inventory of a product may be offered for sale for customers in a particular location and/or for a particular (usually short) time. The reservation is released if the payment fails. When the payment succeeds, and an order is created, the reservation is converted into a permanent (long-term) inventory commitment allocated to a specific location. An inventory component of the commerce management engine 136 may record where variants are stocked, and may track quantities for variants that have inventory tracking enabled. It may decouple product variants (a customer-facing concept representing the template of a product listing) from inventory items (a merchant-facing concept that represents an item whose quantity and location is managed). An inventory level component may keep track of quantities that are available for sale, committed to an order or incoming from an inventory transfer component (e.g., from a vendor).

The merchant may then review and fulfill (or cancel) the order. A review component of the commerce management engine 136 may implement a business process merchant's use to ensure orders are suitable for fulfillment before actually fulfilling them. Orders may be fraudulent, require verification (e.g., ID checking), have a payment method which requires the merchant to wait to make sure they will receive their funds, and the like. Risks and recommendations may be persisted in an order risk model. Order risks may be generated from a fraud detection tool, submitted by a third-party through an order risk API, and the like. Before proceeding to fulfillment, the merchant may need to capture the payment information (e.g., credit card information) or wait to receive it (e.g., via a bank transfer, check, and the like) before it marks the order as paid. The merchant may now prepare the products for delivery. In some embodiments, this business process may be implemented by a fulfillment component of the commerce management engine 136. The fulfillment component may group the line items of the order into a logical fulfillment unit of work based on an inventory location and fulfillment service. The merchant may review, adjust the unit of work, and trigger the relevant fulfillment services, such as through a manual fulfillment service (e.g., at merchant managed locations) used when the merchant picks and packs the products in a box, purchase a shipping label and input its tracking number, or just mark the item as fulfilled. Alternatively, an API fulfillment service may trigger a third-party application or service to create a fulfillment record for a third-party fulfillment service. Other possibilities exist for fulfilling an order. If the customer is not satisfied, they may be able to return the product(s) to the merchant. The business process merchants may go through to “un-sell” an item may be implemented by a return component. Returns may consist of a variety of different actions, such as a restock, where the product that was sold actually comes back into the business and is sellable again; a refund, where the money that was collected from the customer is partially or fully returned; an accounting adjustment noting how much money was refunded (e.g., including if there was any restocking fees or goods that weren't returned and remain in the customer's hands); and the like. A return may represent a change to the contract of sale (e.g., the order), and where the e-commerce platform 100 may make the merchant aware of compliance issues with respect to legal obligations (e.g., with respect to taxes). In some embodiments, the e-commerce platform 100 may enable merchants to keep track of changes to the contract of sales over time, such as implemented through a sales model component (e.g., an append-only date-based ledger that records sale-related events that happened to an item).

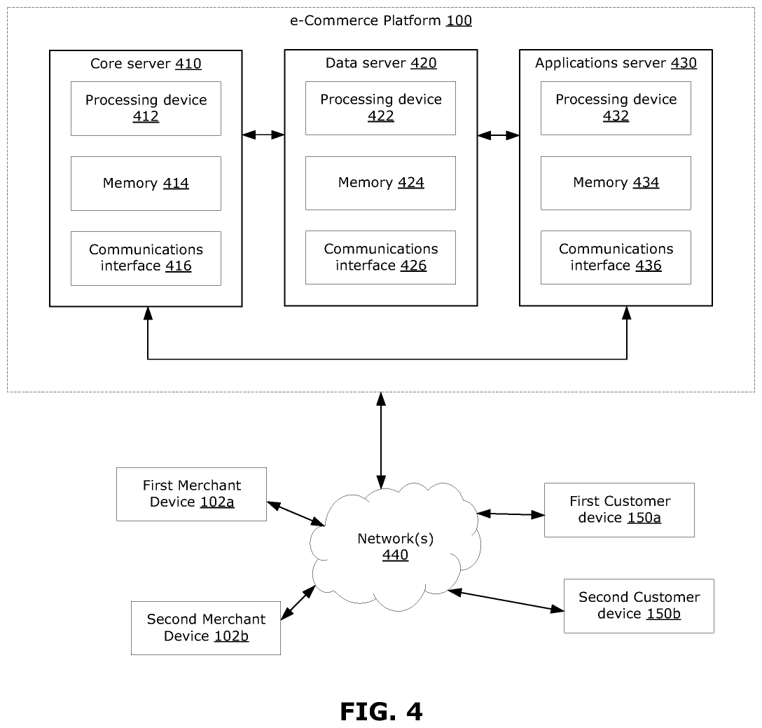

FIG. 4 is a block diagram of an example hardware configuration of the e-commerce platform 100 in communication with multiple merchant devices (102a, 102b . . . ), and multiple customer devices (150a, 150b . . . ).

It should be noted that different components of the e-commerce platform 100 (e.g., the data facility 134, analytics 132, commerce management engine 136 and applications 142A-B) may be implemented in separate hardware or software components, on a common hardware component or server or configured as a common (integrated) service or engine in the e-commerce platform 100. In the example of FIG. 4, the e-commerce platform 100 includes a core server 410, a data server 420 and an applications server 430, which are each in communication with each other (e.g., via wired connections and/or via wireless intranet connections). Each of the servers 410, 420, 430 include a respective processing device 412, 422, 432 (each of which may be, for example, a microprocessor, graphical processing unit, digital signal processor or other computational element), a respective memory 414, 424, 434 (each of which may be, for example, random access memory (RAM), read only memory (ROM), hard disk, optical disc, subscriber identity module (SIM) card, memory stick, secure digital (SD) memory card, and the like, and may include tangible or transient memory), and a respective communications interface 416, 426, 436 (each of which may include transmitter, receiver and/or transceiver for wired and/or wireless communications). The core server 410 may store instructions and perform operations relevant to core capabilities of the e-commerce platform, such as providing the administrator 114, analytics 132, commerce management engine 136, services 116, and/or payment facility 120, among others. The data server 420 may be used to implement the data facility 134, among others. The applications server 430 may store instructions and perform operations relevant to the applications 142A-B, such as storing instructions and data for the applications 142A-B and for implementing application search, recommendation and support 128.

Merchants and customers, using respective devices 102a, 102b, 150a, and 150b may access the e-commerce platform 100 via one or more networks 440 (e.g., wired and/or wireless networks, including a virtual private network (VPN), the Internet, and the like).

Although FIG. 4 illustrates an example hardware implementation of the e-commerce platform 100, it should be understood that other implementations may be possible. For example, there may be greater or fewer numbers of servers, the e-commerce platform 100 may be implemented in a distributed manner, or at least some of the memories 414, 424, 434 may be replaced with external storage or cloud-based storage, among other possible modifications.

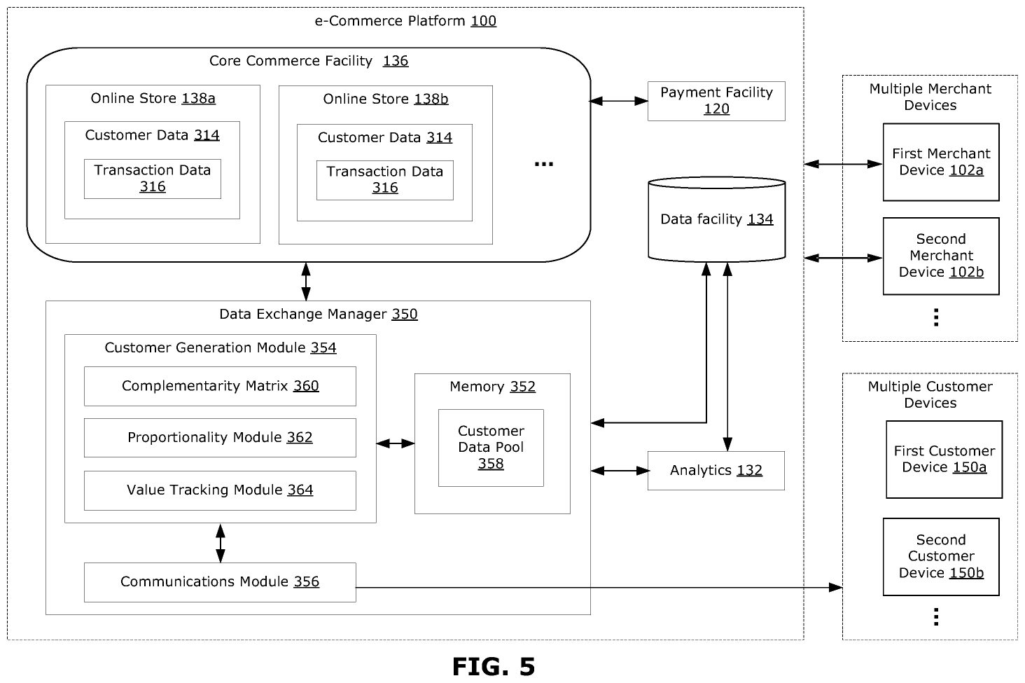

FIG. 5 is another depiction of the e-commerce platform 100 that omits some details that have been described with reference to FIG. 1, and shows further details discussed below. In particular, FIG. 5 illustrates some example details of the e-commerce platform 100 that are relevant to implementing secure data exchange between multiple merchants for targeted communications or advertisements to customers of those multiple merchants.

FIG. 5 illustrates platform payment facility 120 for multiple online stores 138a, 138b etc. on the e-commerce platform 100. Each online store may be associated with one of multiple merchants via merchant devices, such as first merchant device 102a and second merchant device 102b etc. Payment facility 120 enables secure financial transactions with multiple customers, such as through first customer device 150a and second customer device 150b etc.

As noted above, online stores 138a, 138b may process a large volume of customer data 314 on a daily basis for a variety of products and services. This customer data 314 may include any customer information indicative of a customer and a customer account. As illustrated in FIG. 5, customer data 314 also includes transaction data 316, which may include data related to transactions carried out by a customer with a merchant such as, for example, contact information, billing information, shipping information, returns/refund information, discount/offer information, payment information, or online store events or information such as page views, product search information (search keywords, click-through events), product reviews, abandoned carts, and/or other transactional information associated with business through the e-commerce platform 100. In some embodiments, the e-commerce platform 100 may store customer data 314 and its transaction data 316 in a data facility 134.

The e-commerce platform 100 further includes a data exchange manager 350 in communication with the online stores 138a, 138b etc. Data exchange manager 350 is shown to include a memory 352, a customer generation module 354, and a communications module 356.

Memory 352, along with data facility 134, may generally store customer data 314 and transaction data 316 from online stores 138a, 138b etc. Notably, memory 352 includes a customer data pool 358, maintained by e-commerce platform 100, which comprises customer data 314 from a plurality of participating merchants, such as a first merchant and a second merchant. As will be discussed in greater detail below, transaction data 316 in customer data pool 358 further includes information relating to a transaction for a first product between a first customer (of the multiple customers) and a first merchant (of the multiple merchants) who sells, or is associated with, the first product.

As noted above, e-commerce platform 100 already has direct access to customer and transaction data 314, 316 of its online merchants. In such a case, e-commerce platform 100 may verify customer and transaction data 314, 316, including verifying the transaction for the first product between the first customer and the first merchant, and store that data in memory 352 and/or data facility 134.

Accordingly, data exchange manager 350 may be configured to merely receive an indication from a participating merchant, such as the first or second merchant, that the merchant wishes to exchange (portions of) its customer data 314 and transaction data 316 with customer data pool 358. In that regard, data exchange manager 350 may simply transfer or copy the indicated customer and transaction data from memory 352 or data facility 134 to customer data pool 358, without requiring a separate data transfer or data copy from the corresponding online store/merchant.

Customer generation module 354 is configured to generate a target audience comprising target customers using customer data pool 358 for a requesting or interested merchant of the plurality of merchants, where the requesting merchant is associated with (or sells) a second product. For example, core server 410 may store instructions executable by the at least one processor to cause customer generation module 354 to identify a related product that is relevant to the second product (where the second product is associated with the second merchant), identify a collection of customers from customer data pool 358 who have indicated interest in the first product (where the identified collection of customers includes the first customer who has purchased the first product), and then generate a target audience of target customers from the collection of customers (including the first customer), where the size of the target audience is proportional to customer data 316 exchange by the second merchant with the customer data pool 358.

To identify the related product that is relevant to the second product, customer generation module 354 comprises, and uses, a product complementarity or similarity matrix. In the depicted embodiment, a complementarity matrix 360 is shown.

For the second product that is sold by the requesting (or second) merchant, the customer generation module 354 may determine a set of other products that are complementary to the requesting merchant's second product. A pair of products are considered “complementary” if customers who have purchased the first product recently (for example, a purchase of sunscreen in the last 24 hours) are also likely to purchase one of the related products (such as a sunhat). This determination may be performed using the complementarity matrix 360.

Complementarity matrix 360 can be created by looking at a single customer across a defined time period (e.g. 24 hours) and what they have bought (e.g. swimsuit, sunglasses, sunhat), and aggregating that data across all customers, all orders, and all products sold by all of the merchants using e-commerce platform 100. Additionally or alternatively, in some cases, only a subset of the data relating to some or all of the customers, orders, products, merchants may be employed in generating the matrix. For example, the complementarity matrix 360 can be built (or updated) periodically using past historical data (such as weekly, to see which other products were bought by customers within 24 hours of the original purchase in the last week) for all time or for a selected period. In other implementations, the complementarity matrix 360 can be built using the most recent data (e.g. the past 24 hours) to better capture short-term trends that may be happening in real-time. The level of abstraction (or grain) of the entries in the matrix can be at the level of specific products (for example, “SPF50 Sunscreen” sold by “Sunscreens R Us”), or generalized across merchants (for example, abstracted to the item “sunscreen lotion”, which encompasses “SPF50 Sunscreen”, “SPF30 Sunscreen”, and even “SPF60 Sport Sunscreen”). It may be recognized that inputting more data into the complementarity matrix 360 may help to create more accurate complementary associations.

In that case, when a product is purchased from a merchant, the customer generation module 354 uses the complementarity matrix 360 to look up the related product(s) with the closest complementary scores to the originally-purchased product.

The elements of the complementarity matrix 360 may be generated using a number of different methods. For example, it may be done by cosine similarity: i.e. similarity between vector spaces, where each product is represented as a vector, then mapped onto the corresponding multidimensional space such that the distance (e.g. Euclidean) between any two vectors in that multidimensional space can be calculated. Vectors (representing products) that are closest to each other (or have the lowest distance between them) may be considered the most complementary. This can be used to determine the n closest products to the original/first purchased product. A predetermined threshold distance may be imposed to indicate when two products are too far away from each other to be considered complementary, even if the second product is technically the “closest” product to the original product. For example, a really unique product may not be complementary to anything else sold across the other products in the complementarity matrix 360.

The elements of the complementarity matrix 360 may, additionally or alternatively, be generated using association rule learning, which involves association rule algorithms, i.e. rule-based machine learning, for discovering associative/regulative relationships between products in the e-commerce platform's 100 databases. In that regard, the complementarity matrix 360 may be generated using the e-commerce platform's 100 large-scale transaction data 316 of its online merchants.

Other techniques may be used to generate the elements complementarity matrix 360, based on relationship (e.g., similarity or complementarity) between products. Further, it may be that techniques may be used in combination.

In some cases, a similarity (rather than a complementarity) matrix may also be used when identifying a set of related products. For example, if a customer has browsed four candle stores but hasn't bought a candle yet, there is clear intent to buy a candle. Therefore, a matrix that determines a relevant set of products based on similarity (i.e. candles) may be more suitable based on the customer's signals of interest and (lack of) sales activity, rather than a matrix based on complementarity, which would identify products that are complementary to an item the customer hasn't actually purchased yet. In some examples, similarity between two products may be computed based on similarity of the vectors representing those products, without having to reference a similarity matrix, or any matrix at all. In some examples, the similarity between different products may also be represented by elements in the complementarity matrix 360, such that a separate similarity matrix may not be needed.

Once one or more related/complementary product(s) are determined, the customer generation module 354 is configured to identify at least one corresponding merchant (who has also contributed their own customer and transaction data 314, 316 to customer data pool 358) associated with the related/complementary product(s), such as offers the related product for sale.

By way of example, in the present embodiment, the related product that is relevant to the second product (sold by the requesting merchant) may be the first product. The customer generation module 354 then identifies the first merchant as a corresponding merchant who sold the first product to the first customer.

Thus, from all of the customer data and transaction data 314, 316 in the customer data pool 358, the customer generation module 354 identifies a collection of customers who have indicated interest in the first product. In that manner, the identified collection of customers includes the first customer who is associated with (i.e. had purchased) the first product from the first merchant. These collection of customers may be referred to as “warm leads”.

These warm leads are valuable to the requesting merchant because the warm leads have recently purchased a product (the first product) which is related to the second product. This indicates a higher probability that the warm leads will purchase the second product from the requesting merchant. For example, a requesting/second merchant who sells sunhats (i.e. the second product) would be interested in advertising said sunhats to customers who have recently indicated interest in or purchased sunscreen (i.e. the related first product).

Conventionally, the strongest signal of customer interest is an actual purchase transaction, such as the first customer who made the above-mentioned purchase for the first product. However, other activity signals can also be tracked and used to identify the collection of customers, such as entry of the first product into a virtual cart, abandonment of the virtual cart, browsing product pages, searching for products, viewing product reviews, or any other identifiable clickstream data on storefronts. Interest signals may be time-boxed to a recent period of time (e.g. last 24 hours), since that is when they are most relevant to short-term future purchasing. In order for the customer generation module 354 to identify the collection of customers based on recent interest signals, the customers' activity signals must be tracked or monitored in real-time or near real-time. Interest in a product tends to quickly fade over time after the customer's interaction with the product. Thus, the real-time or near real-time tracking is required to maximize the relevance of the identified collection of customers to the requesting merchant. This time sensitivity means that implementations using manual means (e.g., a human monitoring of the interest signals) is not practical or possible without a processor.

It is understood that the requesting/second merchant would be interested in communicating with, or advertising to, all of the warm leads (i.e. all of the collection of customers) in view of those customers' interest in the first product. However, as noted above, it is desirable that this customer data exchange have certain properties including that it be done fairly, such that all merchants are benefitting proportionally from the exchange of data (i.e. the value of incoming customer data should be proportional to the value of outgoing customer data), as well as securely (such that customers' privacy is not compromised).

As such, the customer generation module 354 also includes a proportionality module 362 that is configured to generate a subset target audience of target customers from the collection of customers that is proportional to the incoming customer data from the requesting merchant. In the case when it is the second merchant who is requesting new customer data, the size of the outgoing target audience (limited by the proportionality module 362) is proportional to the customer and transaction data 314, 316 exchanged by the second merchant with the customer data pool 358. In a similar manner, if it is the first merchant who is requesting new customer data, the size of the target audience (limited by the proportionality module 362) would be proportional to the customer and transaction data 314, 316 exchanged by the first merchant with the customer data pool 358.

The proportionality of the outgoing target audience may depend on the amount or volume of customer data exchanged by the second merchant, and/or may depend on the value of the customer data exchanged by the second merchant.

In that regard, the proportionality module 362 may be configured to limit the target audience based on one or more proportionality parameters. A simple parameter may be a direct customer number exchange. For example, if the first merchant contributed customer data relating to two transactions of the purchase of the first product, and is requesting new customer data, the target audience generated by the customer generation module 354 (and limited by the proportionality module 362) for the first merchant may only include two target customers who have indicated interest in (or purchased) a complementary/second product from the second merchant. This may be the case even if the second merchant had sold the second product to twenty other customers.

The proportionality module 362 may also be configured to determine which subset of customers of the collection of customers are to be included in the target audience of target customers (for the merchant who is requesting the new customer data) based on other proportionality parameters, such as predicted conversion rates (e.g. target customer interest scores, product complementarity scores, multi-merchant customer exchange), predicted profit for the requesting merchant, recency of customer data exchanged with the pool by the requesting merchant, and configuration data associated with the requesting merchant.

In the case of using predicted conversion rates, it may be determined per customer and/or per product. For example, customer interest scores may be assessed where customers with stronger customer interest signals (e.g. purchase vs. browsing, recency) may be more worthwhile (and selected as target customers) than those customers with weaker customer interest signals. Product complementarity scores may be assessed where leads (potential target customers) based on extremely complementary products (e.g. cross-country ski boots and cross-country skis) may be more worthwhile than leads from less complementary products (e.g. sunhat and swimsuit). With multi-merchant customer exchange, customers that are exchanged with multiple merchants in the same (or similar) time frame may not be as likely to convert (i.e. customer could opt to buy from one of the other merchants), and thus be less valuable to a merchant as a target customer.

In the case of using predicted profit for the merchant requesting new customer data, predicted gross merchandise value (GMV) rates may be used. In some embodiments, a higher predicted profit to the requesting merchant may be desired, and the target customers may be selected based on whether a given potential target customer is a big spender, and/or whether the potential target customer is associated with an expensive product.

In the case of using (recency of) customer data exchanged with the pool by the requesting merchant, the number of target customers generated may be based on the number of orders and/or customers that have recently purchased products from the requesting merchant (and therefore can be used as part of the target audiences for other merchants). The number of target customers may alternately or also be generated based on the type of products that were recently sold by the requesting merchant. For example, some products may be more useful than others in complementarity matrix 360. For example, selling a highly complementary product versus selling an extremely unique one, would be more valuable to other merchants, who wish to sell their complementary products to customers of the first merchant.

In the case of using the requesting merchant's configurations, the requesting merchant can choose and indicate to data exchange manager 350 when or how their proportion of outgoing customer data (such as recent orders, and customers) is exchanged for incoming customer data.

Proportionality module 362 may further be configured to take the verification of the customer data 314 into account when assessing the value of the customer data provided by the requesting merchant and generating the proportional target audience for the requesting merchant. As previously noted, because the e-commerce platform 100 has direct access to customer and transaction data 314, 316 of its online merchants, the e-commerce platform 100 is able to verify the customer and transaction data 314, 316. The verification performed by the e-commerce platform 100 enables a merchant to have greater confidence in the value of the target audience that is generated (e.g., greater confidence that the target audience contains real customers and not spoofed or inactive customer accounts). For example, a first merchant may provide customer data associated with a first customer to customer data pool 358, where the first customer is associated with a verified transaction with the first merchant. The first merchant may also provide customer data associated with a third customer, where the third customer is not associated with any verified transaction with the first merchant. In such a case, when the first merchant makes a request for new customer information, the number of target customers provided to the first merchant by customer generation module 354 in “exchange” for contribution of the first customer may be greater than the number of target customers provided to the first merchant in “exchange” for contribution of the third customer. This enhances fairness, as the verified transaction data associated with the first customer is more valuable (since the transaction is authenticated by the e-commerce platform 100) than the unverified transaction data associated with the third customer (which is unauthenticated and thus at higher risk of being fake).

Once the customer generation module 354 has generated the target audience with the proportional number of target customers as limited by proportionality module 362 (for the requesting merchant), data exchange manager 350 is configured to exchange the number of target customers with the requesting merchant. The requesting merchant may decide how many of the number of target customers the requesting merchant wishes to pay for to communicate with, or show its advertising.

Effectively, the amount of money the requesting merchant wishes to spend on the targeted advertising may be the inherent determining factor in terms of how many of the target customers the requesting merchant has access to through its targeted ads. In such a case, the number of target customers provided to the requesting merchant by data exchange manager 350 may be ranked (such as according to the above-described parameters) in order to provide the best cost/benefit ratio. In other scenarios, the requesting merchant can be provided with an option to have different ones of the target customers provided with different communications or with different advertisements. It should be noted that, despite ranking the target customers and enabling the requesting merchant to select the ones of the target customers to target, the requesting merchant may not be directly provided with any identifying information about the target customers. That is, the target customers may be ranked according to some parameter, but remain anonymous; the requesting merchant may simply select the ones of the target customer on the basis of the ranked parameter. In this way, the privacy and security of the customer data may be preserved by the data exchange manager 350.

Once data exchange manager 350 has received which or how many of the target customers the requesting merchant wishes to communicate with (or advertise to), communications module 356 is instructed to send the noted communication/advertisement from the requesting merchant to the noted target customers.

In this manner, in order to address privacy and security, customer-identifying information may not be shared directly with the requesting merchant. Instead, e-commerce platform 100 (or another trusted third-party service provider) would manage the communications with the target customers (such as run an email or ad campaign on behalf of the requesting merchant). In that manner, the target audience may only be “accessed” by the requesting merchant through e-commerce platform 100.

In some applications, the e-commerce platform 100 may provide the target advertising to the target audience by providing email marketing, cross-sells/up-sells at checkout, and curated ad space offered by the merchants (e.g. on their online storefronts or at checkout).

In other applications, e-commerce platform 100 may provide the target audience directly to a trusted third-party channel/provider (such as Facebook or Google etc.) via an application programming interface (API). In that regard, identifying information of members of the target audience may be exchanged by the e-commerce platform 100 with the trusted third-party channel for advertising purposes. The identifying information may be provided in a secure manner, for example using a hash algorithm. For example, e-commerce platform 100 may provide hashed email addresses (i.e., hash values generated by applying a hash algorithm to the email addresses) of corresponding members of the target audience to the trusted third-party channel. The target audience may then be subject to various forms of communications or targeted advertisements provided by the requesting merchant through the trusted third-party channels (e.g. Facebook ads, Google ads).

Notably, the requesting merchant is not provided with the customer specific data, that is, until a purchase is made by one of the target customers, during which the usual data required to complete the purchase transaction would be exchanged with the requesting merchant. In that manner, the requesting merchant cannot reuse an email address or otherwise identify the target customer. A corresponding process would be applied for another or first merchant to requests to receive target customers from data exchange manager 350 who have indicated interest in products that are complementary/relevant to the first merchant's first/original product.

Further, even the trusted third-party channel (e.g., advertising service) may be provided with as little information as possible, only enough to enable targeting of advertisements to the target audience. For example, the trusted third-party channel may be provided with only an indicator of the target audience (e.g., hashed addresses), without any information that would link the members of the target audience with each other. For example, the hashed addresses of the target audience may be included with hashed addresses of other customers (who may be targeted with the target advertisement for reasons other than the data exchange), so that the target audience that is generated using the data exchange is not clearly identified. Notably, the third-party channel is not provided with information about product complementarity or similarity, nor information about customers' purchase habits or preferences. The e-commerce platform 100 may be the only party having access to product complementarity or similarity information, and customer purchase or preference information. As such, the third-party channel may not gain any customer information that it would not already have access to.

In the present embodiment, the e-commerce platform 100 is critical to ensure protection of customer privacy. The e-commerce platform 100 acts as a trusted intermediary that ensures customer data 314 is not directly accessed by the receiving merchant. At the same time, because e-commerce platform 100 can verify transaction data 316, e-commerce platform 100 ensures the real value of customer data 316 provided by the merchants. Thus, e-commerce platform 100 resolves the conflicting need for customer privacy and transparency when exchanging customer data 314 between merchants. In some embodiments, both the customers and the merchants may be required to opt-in to be part of this data exchange system.

Customer generation module 354 further includes a value tracking module that is configured to track and assess the requesting merchant's actual conversion rate (i.e. advertising to a target customer that becomes an actual sale), predict the overall “lifetime value” of contribution for any given requesting merchant, and dynamically adjust the number of target customers that will be provided to that requesting merchant.

For example, the requesting merchant's actual conversion rate may be greater or less than an expected conversion rate, where the expected conversion rate is a predetermined conversion rate that is expected to provide a predetermined amount of net benefit to the requesting merchant. In such a case, the size of the target audience/the number of target customers provided to the requesting merchant by customer generation module 354 may be dynamically increased or decreased accordingly. Value tracking module 364 may be configured to repeatedly monitor and adjust the size of the target audience in real-time to bring the actual conversion rate towards the predetermined amount of net benefit to the requesting merchant.

In another example, an estimation of the “lifetime value” may be the cost of contributing customer data 314 to customer data pool 358 versus benefit of contributing that customer data 314 (such as the loss of existing customers versus the increase in new customers). A merchant's existing customer may be lost to a competitor due to contribution of that customer's data to customer data pool 358. However, ideally, every participating merchant should get a net benefit, such as a benefit of no more than three times the merchant's data contribution. Mechanisms such as block-lists (sometimes referred to as “blacklists”) may be provided to participating merchants to prevent key direct competitors from getting their data, in order to mitigate potential losses from exchanging their data. For example, a given merchant may be allowed to provide a block-list identifying other merchants (who may be current merchants of the e-commerce platform 100 or, perhaps, additionally or alternatively merchants who may become merchants of the e-commerce platform 100 in the future) with whom the given merchant does not wish to exchange data via the pool (e.g., a merchant may not wish to exchange data with direct competitors, or with other merchants in the same product category).

Thus, based on value tracking module's 364 live tracking of a requesting merchant's conversion rate and overall lifetime value, customer generation module 354 can adjust the number of identified potential target customers provided to that requesting merchant over time, in order to ensure that the requesting merchant roughly receives the predetermined amount of net benefit.

In some cases, rather than calculating a lifetime contribution, value tracking module 364 may determine an instantaneous or short-term contribution (e.g., a small merchant might start with a low contribution, but the contributions grow over time). For example, the value tracking module 364 may determine the contribution of a requesting merchant over a defined time period (e.g., one week or one month), and the customer generation module 354 may determine the size of the target audience based on the determined contribution of the requesting merchant. Then, after some time (e.g., at regular intervals; at certain anniversaries of having contributed to the customer data pool 358; or when the requesting merchant meets certain milestones, such as reaching a minimum amount of monthly sales), the value tracking module 364 may determine an updated contribution of the requesting merchant over the past time period, and the customer generation module 354 may adjust the size of the target audience accordingly.

Real-time adjustment of the number of identified target customers that is made available to the requesting merchant is a notable benefit of the disclosed system. The ability to monitor and adjust the number of identified target customers in real-time, based on monitored real-time conversion rates, enables data exchange manager 350 to ensure fairness among merchants. Without such real-time monitoring and adjustment, a requesting merchant may benefit from an unexpectedly high conversion rate early in the requesting merchant's advertising campaign (i.e., from a first subset of the identified target audience), but may unfairly continue to target the remainder of the identified target audience, thus gaining more benefit than intended.

Conversely, a requesting merchant who sees a lower than expected conversion rate can be provided with additional target customers to be targeted, thus ensuring the requesting merchant receives a fair benefit. Because the target customers are intended to be “warm leads”, the identification of a target audience and conversion of sales is expected to take place in a short period of time (e.g., within several hours of a customer's first purchase). This time sensitivity means that implementation using manual means (e.g., a human monitoring conversion rates and adjusting audience size) is not practical or possible.

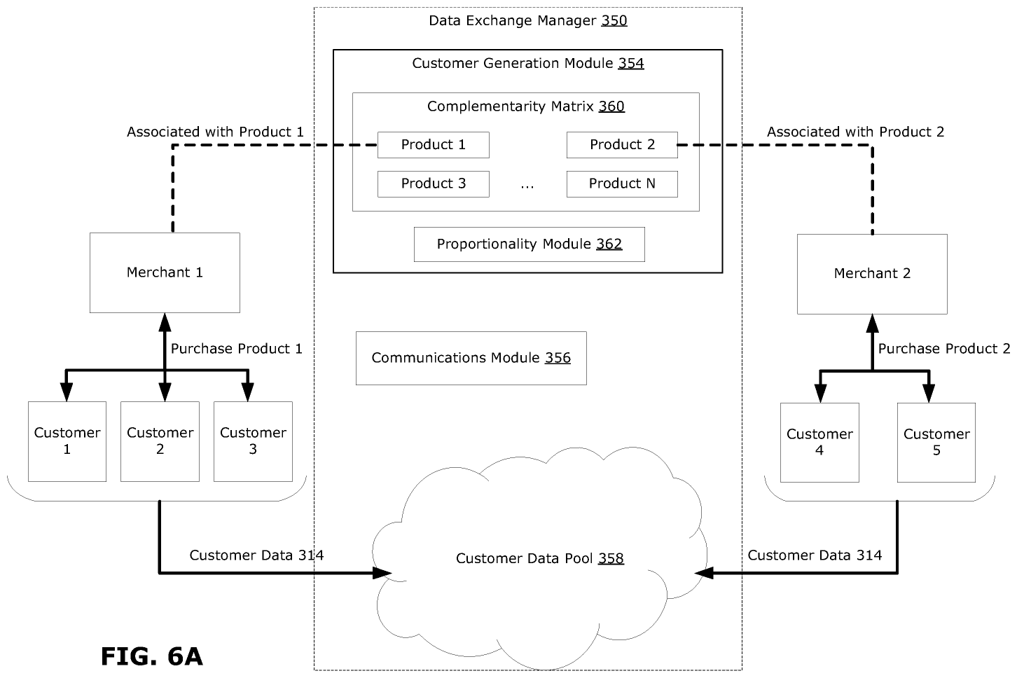

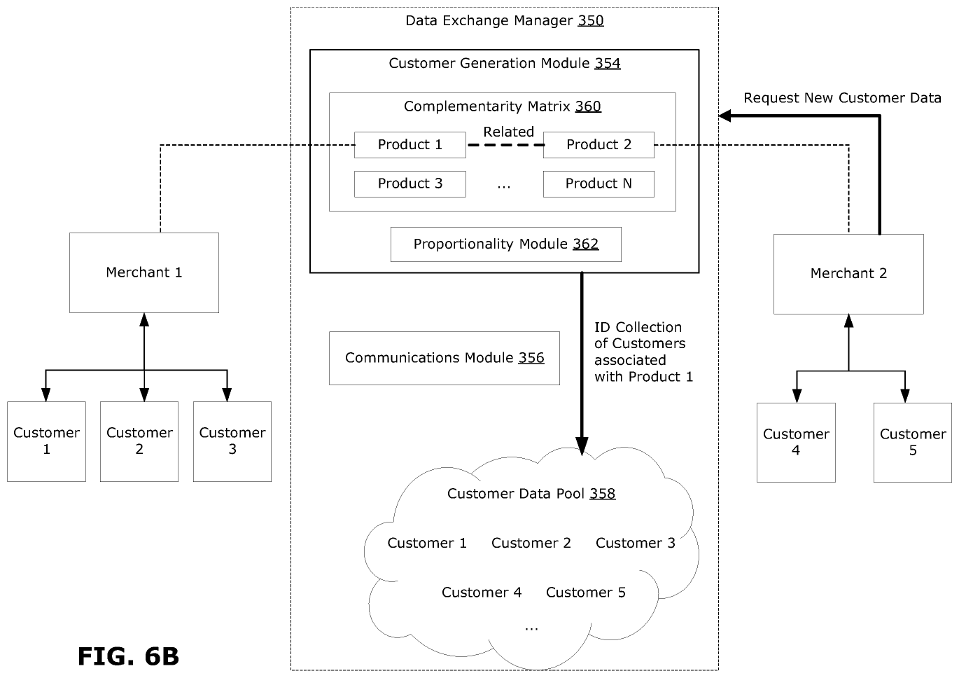

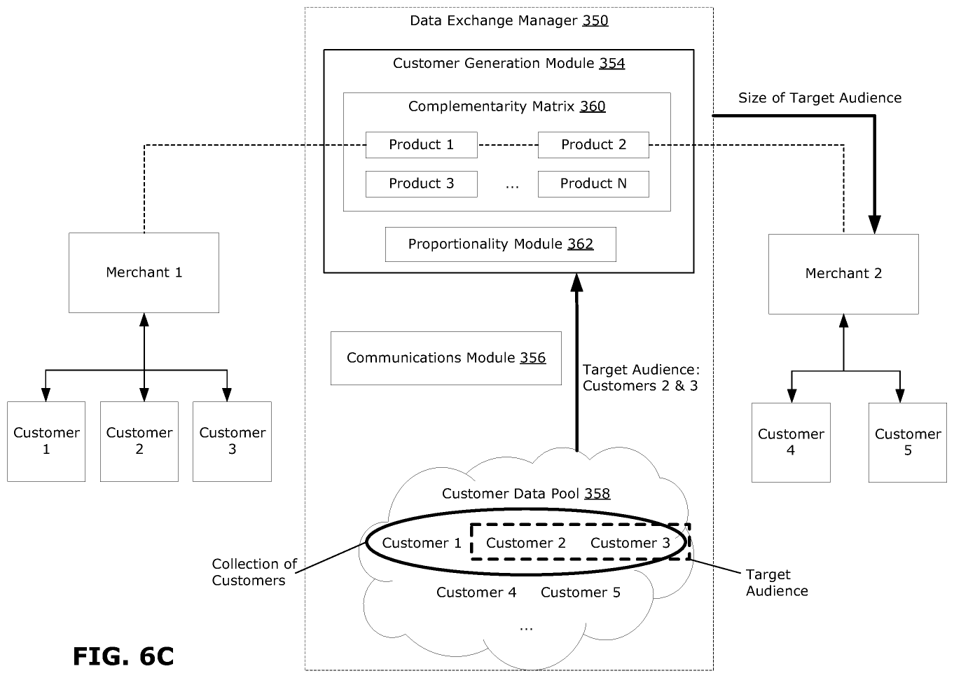

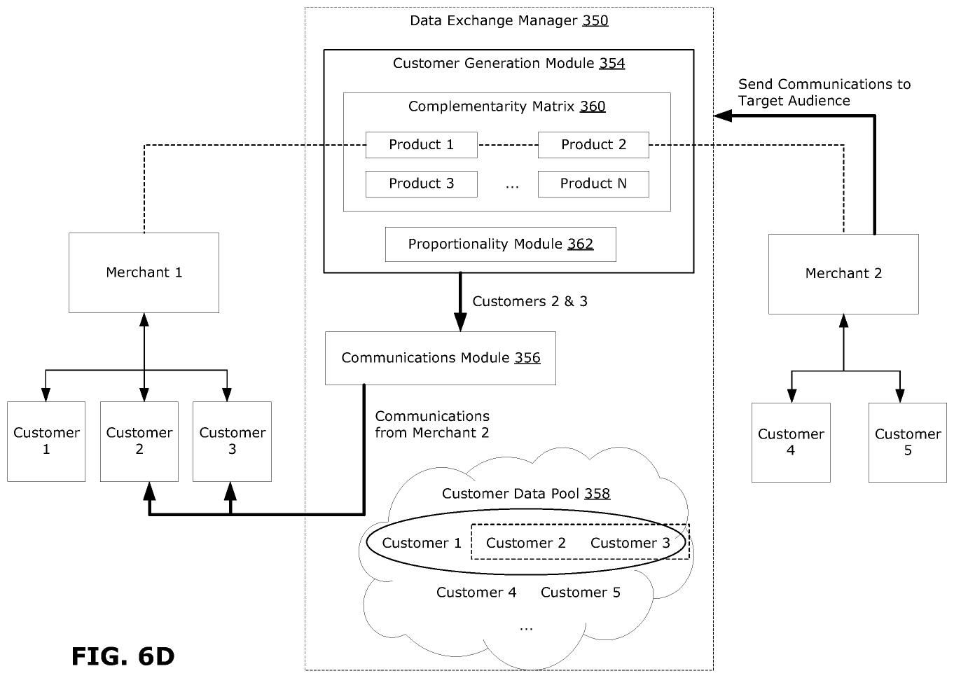

FIGS. 6A to 6D are schematic flow charts illustrating sequential stages in an example customer data exchange using e-commerce platform 100 with data exchange manager 350 of FIG. 5 in accordance with examples of the present disclosure. The data exchange manager 350 may be implemented on the e-commerce platform 100 (e.g., in a server of the e-commerce platform 100), or outside of the e-commerce platform 100 (e.g., in a third-party). However, the following discussion is in the context of an example in which the data exchange manager 350 is implemented in a server of the e-commerce platform 100.

Turning first to FIG. 6A, Merchant 1 is shown having conducted transactions with Customers 1, 2, and 3 for Product 1. Merchant 2 is shown having conducted transactions with Customers 4 and 5 for Product 2. Since Merchants 1 and 2 both wish to participate in the customer data exchange, they both indicate that they will contribute their respective customer data 314 (including transaction data 316) for the transactions related to Products 1 and 2 to customer data pool 358. In that regard, data exchange manager 350 knows that Merchant 1 is associated with Product 1, and Merchant 2 is associated with Product 2. Further, because the respective customer data 314 is associated with transaction data 316 for transactions that have actually taken place (and can be verified by the e-commerce platform 100), the respective customer data 314 can be verified by the data exchange manager 350.

In FIG. 6B, Merchant 2 (who is associated with/sells Product 2) makes a request for new customer information from data exchange manager 350. When that happens, customer generation module 354 uses complementarity matrix 360 to identify a product that is complementary or related to Product 2. In this case, Product 1 is found to be complementary or related to Product 2 according to complementarity matrix 360. Customer generation module 354 then identifies the merchant(s) that are associated with, or has sold, Product 1. In this case, Merchant 1 is identified to be associated with Product 1. Customer generation module 354 then searches customer data pool 358 and identifies the collection of customers who have indicated interest in Product 1.

In FIG. 6C, Customers 1, 2 and 3 (circled in bold) in customer data pool 358 have all recently purchased Product 1 from Merchant 1, thus indicating their interest in Product 1, forming the collection of relevant customers for Merchant 2. However, proportionality module 362 of customer generation module 354 recognizes that Merchant 2 has contributed two customers (Customers 4 and 5) to customer data pool 358. As noted above, proportionality module 362 may use any of the above described proportionality parameters to determine the “fair” size of the generated target audience. If proportionality module 362 applies the simple proportionality parameter of direct number of customer exchange, Merchant 2 proportionally should receive a target audience with two target customers, as they had contributed customer data related to two customers. In such a case, customer generation module 354 generates a target audience of two target customers (for example, Customers 2 and 3, indicated with a bold dashed box) to be provided to Merchant 2, and Merchant 2 is provided with the size (two) of the target audience.

In FIG. 6D, if/when Merchant 2 decides to send communications to the provided target audience, data exchange manager 350 receives this instruction and has communications module 356 send Merchant 2's communication/advertisement to Customers 2 and 3 for Product 2. In this manner, the customer data of Merchant 1 that is associated with the target audience is not disclosed to Merchant 2, so that the customers' privacy is not compromised.

Following Merchant 2's communication/advertisements to Customers 2 and 3, Customers 2 and/or 3 may become customers of Merchant 2 if they purchase Product 2 from Merchant 2. If such a transaction occurs, the transaction(s) are monitored by value tracking module 364 as Merchant 2's actual conversion rate. For example, if Customer 2 purchases Product 2 from Merchant 2, Merchant 2's actual conversion rate is 50%. As noted above, value tracking module 364 may monitor Merchant 2's actual conversion rate and lifetime value, and may dynamically adjust the number of target customers that customer generation module 354 will provide to Merchant 2 the next time Merchant 2 requests new customer data from data exchange manager 350.

Further to the above example, if the expected conversion rate is, say, 75%, Merchant 2's actual conversion rate of 50% is lower than the predetermined/desired rate. In such a case, the next time Merchant 2 makes a request for new customer data, value tracking module 364 may take note of the lower than expected actual conversion rate, calculate Merchant 2's overall lifetime value, and accordingly, dynamically increase the size of the subsequent target audience to be provided to Merchant 2. For example, after Merchant 2 makes a subsequent request for new customer data and the collection of customers for Product 1 is identified as described above, Merchant 2 may subsequently be provided with four new target customers. In this manner, the specific target customers provided may be dynamically changed in response to the collected interest signals collected in real-time/near real-time, and the number of target customers provided may be dynamically changed in response to Merchant 2's actual conversion rate and overall lifetime value. As noted above, such real-time, secure, and multi-faceted data exchange must be implemented on a processor, as no amount of human diligence can provide the same relevant response.

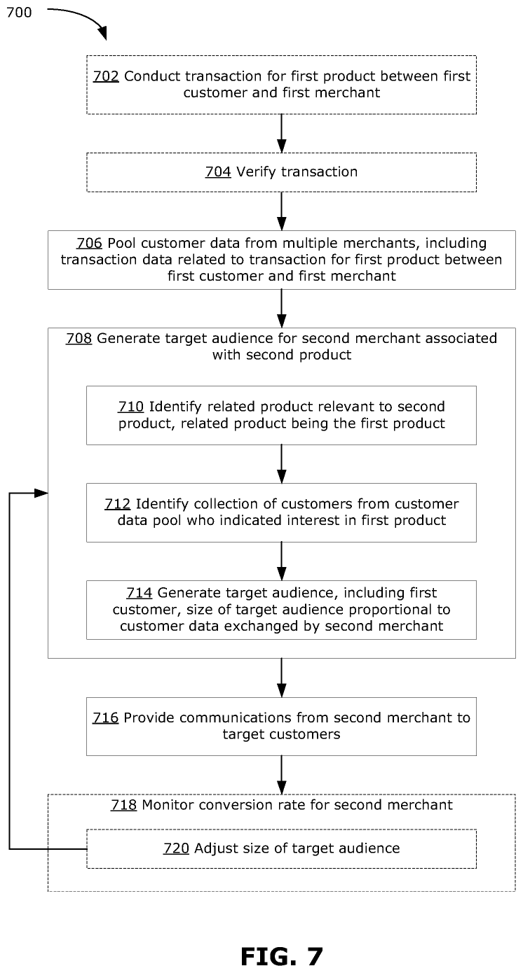

FIG. 7 is a flowchart illustrating an example method 700 for providing secure exchange of customer data between merchants. The example method 700 may be performed by the e-commerce platform 100 using the data exchange manager 350, for example. In particular, the method 700 may be performed in real-time (or near real-time) during transaction processes at a given online store 138a, 138b by a given customer.

At an operation 702, a transaction may be conducted between a first customer and a first merchant for a first product. The transaction may be conducted on e-commerce platform 100 using payment facility 120. Optionally, at an operation 704, the transaction may be verified by e-commerce platform 100, and the related customer and transaction data may be stored in data facility 134 and/or memory 352 of data exchange manager 350.

At an operation 706, the customer data from a plurality of merchants, including the first merchant, may be pooled together in a customer data pool maintained by the e-commerce platform 100. The customer data may include transaction data associated with transactions between the plurality of merchants and customers of those plurality of merchants. In particular, the transaction data may include the data for the transaction for the first product between the first customer and the first merchant.

If method 700 is implemented on the e-commerce platform 100, as noted above, the e-commerce platform 100 already has access to the customer and transaction data of the multiple merchants. In such a case, rather than the first, second or plurality of merchants separately sending their customer data to the data exchange manager 350, data exchange manager 350 may simply receive indications from the first, second or plurality of merchants that their respective customer data is to be exchanged with the customer data pool 358.

At an operation 708, the customer data pool may be used to generate a target audience for a second merchant of the plurality of merchants, where the second merchant is associated with a second product. In other words, when the second merchant requests for new customer data/information from data exchange manager 350, data exchange manager 350 uses the customer data pool to generate a target audience for the second merchant. In that regard, the generating may involve a number of operations.

At an operation 710, a related product that is relevant to the second product (sold by the second merchant) is identified. In the present embodiment, a product complementarity or similarity matrix, as described above, is used to identify the related product that is relevant to the second product. In the present case, the related product is the first product. The merchant(s) associated with the first product is then also identified, in this case, the first merchant.

At an operation 712, a collection of customers who have indicated interest in the first product is identified from the customer data pool. Since the first customer had purchased the first product from the first merchant, the identified collection of customers may include the first customer. Other indicators of interest, besides purchase of the first product, may be tracked and used to identify customers who are interested in the first product. For example, other indicators that may be tracked and used include entry of the first product into a virtual cart, viewing a product page containing the first product, searching for the first product, and/or viewing a review of the first product.

At an operation 714, a target audience of target customers are then generated from the collection of customers, where the target customers may include the first customer. Notably, the size of the target audience is limited to be proportional to the customer data exchanged by the second merchant with the customer data pool. For example, the outgoing target audience may be proportional to the amount or volume of customer data exchanged by the second merchant, and/or the outgoing target audience sent to the second merchant may be proportional to the value of the customer data exchanged by the second merchant.

As noted above, a proportionality module 362 may be used to limit the target audience based on one or more proportionality parameters in view of the customer data exchanged by the second merchant. As discussed previously, those proportionality parameters may be simple, such as a direct numerical customer number exchange. Alternately or additionally, they may involve more complicated parameters, such as predicted conversion rates, target customer interest scores, product complementarity scores, multiple merchants previously targeting the target customer, predicted profit for the second merchant, recency of customer data exchanged with the pool by the second merchant, and configuration data associated with the second merchant.

Optionally, in selecting which customers of the collection of customers to include in the target audience, method 700 may include ranking the customers in the collection of customers according to the one or more of the proportionality parameters, and selecting the top n customers to be in the target audience.

When generating the target audience, verification of the transaction (such as at 704) may also be taken into account to assess the value of the customer data contributed by the second merchant. Verified transaction data is understood to be more valuable than unverified transaction data, since the unverified data may not relate to an authentic transaction. In such a case, if the second merchant contributes customer data that is associated with a verified transaction with the second merchant, and customer data that is associated with an unverified transaction with the second merchant, the number of target customers that would be provided to the second merchant in exchange for the verified customer data would be higher than the number of target customers that would be provided to the second merchant in exchange for the unverified customer data.

If performed on the e-commerce platform 100, the customer data may be verified by the e-commerce platform 100, since the platform already has direct access to sales/transaction/product view/abandoned cart data. This may help increases trust in the present system and method, and may help to speed up the process as the merchants' data may not need to be, otherwise, commercially verified.

Once the target audience for the second merchant has been generated, the second merchant may be notified of the size of their generated target audience. It is notable that the second merchant would not be provided with identifying customer information/data that is associated with the target customers. It may be that, in this way, privacy impacts of conventional sharing of customer data may be avoided or limited. Optionally, the second merchant may send an indication as to how many target customers of the target audience the second merchant wishes to send its communication or advertisement to. For example, if the second merchant was provided with access to a generated audience of ten target customers, the second merchant may indicate to the data exchange manager 350 that he/she wishes to send advertisements to all ten, less than ten, or none of them.

The second merchant may also have the option of sending different advertisements to different target customers in the target audience. For example, the second merchant may indicate that he/she wishes to send a first advertisement to five of the ten target customers, and send a second advertisement to the other five of the ten target customers.

At an operation 716, the noted communications or advertisements from the second merchant are provided to the one or more of the target customers of the target audience without disclosing the customer data associated with the target audience to the second merchant. In this manner, if performed using the e-commerce platform 100, the e-commerce platform 100 hides the specific, identifying customer data from the merchants, so the merchants cannot directly (or otherwise) contact the identified target customers. This provides an extra layer of privacy protection and security to the customers.

Optionally, at an operation 718, an actual conversion rate of the one or more target customers for the second merchant may be monitored in real time. As noted above, the actual conversion rate would be the number of purchases of the second product from the second merchant by the one or more target customers who received the communications or advertisement.

In response to determining that the actual conversion rate differs from an expected conversion rate (where the expected conversion rate is an expected number of purchases of the second product from the second merchant by the one or more target customers who received the communications), at an operation 720, the size of the target audience provided to the second merchant may be adjusted the next time the second merchant makes a request for new customer data. In that manner, the monitoring and the adjusting may be repeated in real-time in order to bring the actual conversion rate towards a predetermined amount of net benefit to the second merchant.

Until this point, operation 708 has been described for when the second merchant makes a request for new customer data. It would be well understood that a corresponding method would apply if the first merchant (or another participating merchant from the plurality of merchants) were to make a request for new customer data.

For example, if the first merchant were to make a request for new customer data, another collection of customers who have indicated interest in the second product (that is associated with the second merchant) would be identified from the customer data pool, including a second customer who is associated with (or purchased) the second product from the second merchant. This would be based on the prior example where the first product is/was found to be related (or complementary/similar) to the second product. Another target audience of other target customers would be generated from the other collection of customers, where the size of other target audience would be proportional to the volume and/or value of the customer data exchanged by the first merchant with the customer data pool. In this case, communications from the first merchant would then be provided to one or more of the other target customers of the other target audience without disclosing the customer data associated with the other target audience to the first merchant.

A technical advantage of using the e-commerce platform is that it has direct access to the customer data as well as transaction data, which allows the e-commerce platform to track and calculate a merchant's actual conversion rate and overall lifetime value to the customer data pool in real-time. The e-commerce platform can dynamically adjust the number of identified target customers provided to that merchant over time in response to actual transactions, in order to ensure that the merchant roughly receives the predetermined amount of net benefit.

The ability to monitor and adjust the exchanged customer data in real-time, based on monitored real-time customer activity (e.g., customer conversion rate), helps to ensure fairness among merchants. The time sensitivity means that a human cannot and does not have the physical capacity to monitor the conversion rates in the same way. Further, the disclosed systems and methods provide a secure way to exchange customer data among merchants, without unnecessary exposure of sensitive customer data to third-party merchants. Such security relies on the use of trusted electronic platforms as an intermediary (such as e-commerce platform 100), and, thus, also cannot be replicated using manual means.

Although the present disclosure describes methods and processes with operations (e.g., steps) in a certain order, one or more operations of the methods and processes may be omitted or altered as appropriate. One or more operations may take place in an order other than that in which they are described, as appropriate.

Although the present disclosure is described, at least in part, in terms of methods, a person of ordinary skill in the art will understand that the present disclosure is also directed to the various components for performing at least some of the aspects and features of the described methods, be it by way of hardware components, software or any combination of the two. Accordingly, the technical solution of the present disclosure may be embodied in the form of a software product. A suitable software product may be stored in a pre-recorded storage device or other similar non-volatile or non-transitory computer readable medium, including DVDs, CD-ROMs, USB flash disk, a removable hard disk, or other storage media, for example. The non-transitory software product includes instructions tangibly stored thereon that enable a processing device (e.g., a personal computer, a server, or a network device) to execute examples of the methods disclosed herein.

The present disclosure may be embodied in other specific forms without departing from the subject matter of the claims. The described example embodiments are to be considered in all respects as being only illustrative and not restrictive. Selected features from one or more of the above-described embodiments may be combined to create alternative embodiments not explicitly described, features suitable for such combinations being understood within the scope of this disclosure.

All values and sub-ranges within disclosed ranges are also disclosed. Also, although the systems, devices and processes disclosed and shown herein may comprise a specific number of elements/components, the systems, devices and assemblies could be modified to include additional or fewer of such elements/components. For example, although any of the elements/components disclosed may be referenced as being singular, the embodiments disclosed herein could be modified to include a plurality of such elements/components. The subject matter described herein intends to cover and embrace all suitable changes in technology.

1. A computer-implemented method comprising:
pooling customer data associated with a plurality of merchants in a customer data pool maintained by an e-commerce platform, the customer data including transaction data associated with transactions between the plurality of merchants and customers of those plurality of merchants, the transaction data including data for a transaction for a first product between a first customer of a first merchant of the plurality of merchants and the first merchant;
using the customer data pool to generate a target audience for a second merchant of the plurality of merchants, the second merchant being associated with a second product, the generating including:
identifying a related product relevant to the second product, the related product being the first product associated with the first merchant;
identifying, from the customer data pool, a collection of customers who have indicated interest in the first product, the identified collection of customers including the first customer who is associated with the first product; and
generating a target audience of target customers from the collection of customers, including the first customer, wherein a size of the target audience is proportional to customer data exchanged by the second merchant with the customer data pool; and
providing communications from the second merchant to one or more of the target customers of the target audience without disclosing the customer data associated with the target audience to the second merchant.

2. The computer-implemented method of claim 1, further comprising:
prior to pooling the customer data, verifying the transaction for the first product between the first customer and the first merchant, and storing, by the e-commerce platform, the data for the transaction.

3. The computer-implemented method of claim 2, further comprising:
identifying, from the customer data pool, another collection of customers who have indicated interest in the second product, the identified other collection of customers including a second customer who is associated with the second product;
generating another target audience of other target customers from the other collection of customers, wherein a size of the other target audience is proportional to customer data exchanged by the first merchant with the customer data pool; and
providing communications from the first merchant to one or more of the other target customers of the other target audience without disclosing the customer data associated with the other target audience to the first merchant.

4. The computer-implemented method of claim 3, wherein the customer data exchanged by the first merchant includes:
customer data associated with the first customer, the first customer being associated with the verified transaction with the first merchant; and
customer data associated with a third customer, the third customer not being associated with any verified transaction with the first merchant;
wherein a generated number of other target customers that is proportional to the customer data associated with the first customer is larger than a generated number of other target customers that is proportional to the customer data associated with the third customer.

5. The computer-implemented method of claim 1, wherein the pooling comprises:
receiving, from the first merchant, an indication that customer data of the first merchant should be exchanged with the customer data pool.

6. The computer-implemented method of claim 1, further comprising:
receiving, from the second merchant, a number of target customers of the target audience that the second merchant wishes to provide the communications to.

7. The computer-implemented method of claim 1, further comprising:
monitoring an actual conversion rate of the one or more target customers for the second merchant in real time, the actual conversion rate being a number of purchases of the second product from the second merchant by the one or more target customers who received the communications; and
responsive to determining that the actual conversion rate differs from an expected conversion rate, the expected conversion rate being an expected number of purchases of the second product from the second merchant by the one or more target customers who received the communications, adjusting the size of the target audience,
wherein the monitoring and the adjusting are repeated in real-time to bring the actual conversion rate towards a predetermined amount of net benefit to the second merchant.

8. The computer-implemented method of claim 1, further comprising conducting the transaction between the first customer and the first merchant.

9. The computer-implemented method of claim 1, wherein the target customers of the target audience is generated further based on one or more proportionality parameters, including at least one of:
predicted conversion rates;
target customer interest scores;
product complementarity scores;
multiple merchants previously targeting the target customer;
predicted profit for the second merchant;
recency of customer data exchanged with the pool by the second merchant; or
configuration data associated with the second merchant.

10. The computer-implemented method of claim 9, further comprising ranking the target customers according to the one or more proportionality parameters.

11. The computer-implemented method of claim 1, wherein the collection of customers from the customer data pool are identified by indicated interest in the first product, wherein indicated interest is determined by tracking at least one of:
a purchase of the first product;
entry of the first product into a virtual cart;
viewing a product page containing the first product;
search for the first product; or
viewing a review of the first product.

12. The computer-implemented method of claim 1, wherein identifying the second product that is relevant to the first product is based on a complementarity or similarity matrix.

13. A computer system comprising:
at least one processor and at least one memory, the at least one memory storing a customer data pool comprising customer data associated with a plurality of merchants maintained by an e-commerce platform, the customer data including transaction data associated with transactions between a plurality of merchants and customers of the plurality of merchants, the transaction data including data for a transaction for a first product between a first customer of a first merchant of the plurality of merchants and the first merchant, and the at least one memory further storing instructions executable by the at least one processor to cause the computer system to:
generate a target audience using the customer data pool for a second merchant of the plurality of merchants, the second merchant being associated with a second product, by:
identifying a related product relevant to the second product, the related product being the first product associated with the first merchant;
identifying, from the customer data pool, a collection of customers who have indicated interest in the first product, the identified collection of customers including the first customer who is associated with the first product; and
generating a target audience of target customers from the collection of customers, including the first customer, wherein a size of the target audience is proportional to customer data exchanged by the second merchant with the customer data pool; and
provide communications from the second merchant to one or more of the target customers of the target audience without disclosing the customer data associated with the target audience to the second merchant.

14. The computer system of claim 13, wherein the instructions executable by the at least one processor further cause the computer system to:
verify the transaction for the first product between the first customer and the first merchant, and store the data for the transaction in the at least one memory.

15. The computer system of claim 14, wherein the instructions executable by the at least one processor further cause the computer system to:
identify, from the customer data pool, another collection of customers who have indicated interest in the second product, the identified other collection of customers including a second customer who is associated with the second product;
generate another target audience of other target customers from the other collection of customers, wherein a size of the other target audience is proportional to customer data exchanged by the first merchant with the customer data pool; and
provide communications from the first merchant to one or more of the other target customers of the other target audience without disclosing the customer data associated with the other target audience to the first merchant.

16. The computer system of claim 15, wherein the customer data exchanged by the first merchant includes:
customer data associated with the first customer, the first customer being associated with the verified transaction with the first merchant; and
customer data associated with a third customer, the third customer not being associated with any verified transaction with the first merchant; and
wherein a generated number of other target customers that is proportional to the customer data associated with the first customer is larger than a generated number of other target customers that is proportional to the customer data associated with the third customer.

17. The computer system of claim 13, wherein the instructions executable by the at least one processor further cause the computer system to:
receive, from the first merchant, an indication that customer data of the first merchant should be exchanged with the customer data pool.

18. The computer system of claim 13, wherein the instructions executable by the at least one processor further cause the computer system to:
monitor an actual conversion rate of the one or more target customers for the second merchant in real time; and
responsive to determining that the actual conversion rate differs from an expected conversion rate, adjusting the size of the target audience;
wherein the monitoring and the adjusting are repeated in real-time to bring the actual conversion rate towards a predetermined amount of net benefit to the second merchant.

19. The computer system of claim 13, wherein the target audience is generated based on one or more proportionality parameters, including at least one of:
predicted conversion rates;
target customer interest scores;
product complementarity scores;
multiple merchants previously targeting the target customer;
predicted profit for the second merchant;
recency of customer data exchanged with the pool by the second merchant; or
configuration data associated with the second merchant.

20. A computer-readable medium storing instructions that, when executed by a processor of a system, causes the system to:
pool customer data associated with a plurality of merchants in a customer data pool maintained by an e-commerce platform, the customer data including transaction data associated with transactions between the plurality of merchants and customers of those plurality of merchants, the transaction data including data for a transaction for a first product between a first customer of a first merchant of the plurality of merchants and the first merchant;
generate a target audience for a second merchant of the plurality of merchants using the customer data pool, the second merchant being associated with a second product, the generation including:
identifying a related product relevant to the second product, the related product being the first product associated with the first merchant;
identifying, from the customer data pool, a collection of customers who have indicated interest in the first product, the identified collection of customers including the first customer who is associated with the first product; and
generating a target audience of target customers from the collection of customers, including the first customer, wherein a size of the target audience is proportional to customer data exchanged by the second merchant with the customer data pool; and
provide communications from the second merchant to one or more of the target customers of the target audience without disclosing the customer data associated with the target audience to the second merchant.
